(19) United States
(12) Patent Application Publication
(10) Pub. No.: US 2020/0386189 A1
(43) Pub. Date: Dec. 10, 2020

(54) High Speed Aircraft Flight Technologies

(71) Applicant: General Electric Company, Schenectady, NY (US)

(72) Inventors: Brandon Flowers Powell, Mason, OH (US); Narendra Digamber Joshi, Schenectady, NY (US); Timothy John Sommerer, Ballston Spa, NY (US); Nicholas William Rathay, Rock City Falls, NY (US); William Dwight Gerstler, Niskayuna, NY (US); Kapil Kumar Singh, Rexford, NY (US); Brandon Wayne Miller, Liberty Township, OH (US)

(21) Appl. No.: 16/857,570

(22) Filed: Apr. 24, 2020

Related U.S. Application Data
(60) Provisional application No. 62/840,697, filed on Apr. 30, 2019.

(51) Int. Cl. F02K 7/16; B64C 30/00; B64D 27/12; B64D 33/02; B64D 33/04; B64D 33/08; F02K 3/02

(52) U.S. Cl. CPC F02K 7/16; B64C 30/00; B64D 27/12; B64D 33/02; B64D 2033/026; B64D 33/08; F02K 3/025; B64D 2033/024; B64D 33/04

(57) ABSTRACT

A hypersonic propulsion engine includes: a turbine engine including a compressor section, a combustion section, and a turbine section arranged in serial flow order, the turbine engine defining a turbine engine inlet upstream of the compressor section and a turbine engine exhaust downstream of the turbine section; a ducting assembly defining a bypass duct having a substantially annular shape and extending around the turbine engine, an afterburning chamber located downstream of the bypass duct and at least partially aft of the turbine engine exhaust, and an inlet section located at least partially forward of the bypass duct and the turbine engine inlet; and an inlet precooler positioned at least partially within the inlet section of the ducting assembly and upstream of the turbine engine inlet, the bypass duct, or both for cooling an airflow provided through the inlet section of the ducting assembly to the turbine engine inlet, the bypass duct, or both.

### PRIORITY INFORMATION

The present application claims priority to U.S. Provisional Patent Application Ser. No. 62/840,697 filed on 30 Apr. 2019, which is incorporated by reference herein.

### FIELD

The present subject matter relates generally technologies allowing for high speed aircraft flight.

### BACKGROUND

High-speed hypersonic propulsion engines may facilitate supersonic and hypersonic air transport. Operating at such high speeds creates many issues not present, or less prevalent, in subsonic and supersonic flight operations. For example, thermal management becomes much more of an issue at high speed operations due to the increased amount of heat generated from hypersonic shock waves at hypersonic flight speeds. Accordingly, improvements to aircraft and hypersonic propulsion engines for aircraft that help overcome these issues would be useful.

### BRIEF DESCRIPTION

Aspects and advantages of the invention will be set forth in part in the following description, or may be obvious from the description, or may be learned through practice of the invention.

In one exemplary embodiment of the present disclosure, a hypersonic propulsion engine is provided. The engine includes: a turbine engine including a compressor section, a combustion section, and a turbine section arranged in serial flow order, the turbine engine defining a turbine engine inlet upstream of the compressor section and a turbine engine exhaust downstream of the turbine section; a ducting assembly defining a bypass duct having a substantially annular shape and extending around the turbine engine, an afterburning chamber located downstream of the bypass duct and at least partially aft of the turbine engine exhaust, and an inlet section located at least partially forward of the bypass duct and the turbine engine inlet; and an inlet precooler positioned at least partially within the inlet section of the ducting assembly and upstream of the turbine engine inlet, the bypass duct, or both for cooling an airflow provided through the inlet section of the ducting assembly to the turbine engine inlet, the bypass duct, or both.

In certain exemplary embodiments the inlet precooler is positioned upstream of the turbine engine inlet for cooling an airflow provided through the inlet section of the ducting assembly to the turbine engine inlet.

In certain exemplary embodiments the inlet precooler is positioned upstream of both the turbine engine inlet and the bypass duct for cooling an airflow provided through the inlet section of the ducting assembly to the turbine engine inlet and the bypass duct.

In certain exemplary embodiments, the hypersonic propulsion engine further includes a fan located forward of the turbine engine inlet and driven by a turbine section of the turbine engine.

In certain exemplary embodiments the fan is located downstream of the inlet precooler.

In certain exemplary embodiments the fan includes a plurality of fan blades, and wherein each of the plurality of fan blades are formed of a ceramic matrix composite material.

In certain exemplary embodiments, the hypersonic propulsion engine further includes a stage of guide vanes, wherein the fan includes a plurality of fan blades, wherein the stage of guide vanes is located downstream of the plurality of fan blades of the fan and upstream of the turbine engine inlet.

In certain exemplary embodiments the stage of guide vanes is a stage of variable guide vanes.

In certain exemplary embodiments the turbine engine defines a cooling duct for a cooling fluid, wherein the fan includes a plurality of fan blades, and wherein the plurality of fan blades are in fluid communication with the cooling duct for receiving at least a portion of the cooling fluid for cooling the plurality of fan blades.

In certain exemplary embodiments the bypass duct includes a dual stream section, wherein the dual stream section includes an inner bypass duct stream and an outer bypass duct stream, and wherein the inner bypass duct stream and the outer bypass duct stream are in a parallel flow configuration.

In certain exemplary embodiments the compressor section includes a compressor having a stage of compressor rotor blades, wherein each compressor rotor blade of the stage of compressor rotor blades defines a radially outer end, wherein the ducting assembly includes a stage of airfoils positioned at least partially within the inner bypass duct stream, and wherein the stage of airfoils of the ducting assembly is coupled to the stage of compressor rotor blades at the radially outer ends of the respective compressor rotor blades of the stage of compressor rotor blades.

In certain exemplary embodiments the stage of airfoils is a stage of compression airfoils.

In certain exemplary embodiments the bypass duct includes an outer bypass duct stream door located at an upstream end of the outer bypass duct stream and movable between a closed position and an open position, wherein the outer bypass duct stream door substantially completely blocks the outer bypass duct stream when in the closed position, and wherein the outer bypass duct stream door allows airflow through the outer bypass duct stream when in the open position.

In certain exemplary embodiments the turbine engine further includes an engine shaft and one or more bearings supporting the engine shaft, and wherein the one or more bearings are configured as air bearings.

In certain exemplary embodiments, the hypersonic propulsion engine further includes an augmenter positioned at least partially within the afterburning chamber.

In certain exemplary embodiments the afterburning chamber is a hyperburner chamber.

In certain exemplary embodiments the augmenter is a rotating detonation combustor.

In certain exemplary embodiments the rotating detonation combustor defines a plurality of fuel holes arranged along a circumferential direction, wherein the plurality of fuel holes includes a first set of fuel holes and a second set of fuel holes, wherein the first set of fuel holes are configured to introduce more fuel to the afterburning chamber per individual fuel hole than the second set of fuel holes per individual fuel hole.

In certain exemplary embodiments the afterburning chamber defines a nozzle outlet and an afterburning chamber axial length between the turbine engine exhaust and the nozzle outlet, wherein the turbine engine defines a turbine engine axial length between the turbine engine inlet and the turbine engine exhaust, and wherein the afterburning chamber axial length is at least about 75% of the turbine engine axial length and up to about 500% of the turbine engine axial length.

In certain exemplary embodiments the afterburning chamber axial length is greater than the turbine engine axial length.

In certain exemplary embodiments, the hypersonic propulsion engine further includes a fuel delivery system for providing a flow of fuel to the combustion section of the turbine engine, wherein the inlet precooler is a fuel-air heat exchanger thermally coupled to the fuel delivery system.

In certain exemplary embodiments the turbine engine defines a core air flowpath extending between the turbine engine inlet and the turbine engine exhaust, and wherein the turbine engine includes an intercooler in thermal communication with an airflow through the core air flowpath.

In certain exemplary embodiments the compressor section includes a first compressor, wherein the turbine engine further includes a plurality of struts extending through the core air flowpath in a location upstream of the first compressor, and wherein the intercooler is integrated at least partially into the plurality of struts.

In certain exemplary embodiments, the hypersonic propulsion engine further includes a fuel delivery system for providing a flow of fuel to the combustion section of the turbine engine, wherein the inlet intercooler is a fuel-air heat exchanger thermally coupled to the fuel delivery system.

In certain exemplary embodiments the fuel delivery system includes a fuel oxygen reduction unit for reducing an oxygen content of a fuel flow through the fuel delivery system.

In certain exemplary embodiments, the hypersonic propulsion engine further includes: a flowpath wall defining a flowpath surface, the flowpath surface exposed to substantially hypersonic airflow during operation of the hypersonic propulsion engine; and a cooling assembly thermally operable with the flowpath surface for reducing a temperature of the flowpath surface.

The hypersonic propulsion engine of claim 26, wherein the flowpath wall includes a porous section, and wherein the cooling assembly includes a cooling fluid configured to diffuse through the porous section of the flowpath wall to the flowpath surface during operation of the hypersonic propulsion engine.

In certain exemplary embodiments cooling fluid is a metal phase change material.

In certain exemplary embodiments the porous section is a variable porous section varying along the flowpath wall.

In certain exemplary embodiments the flowpath surface includes a plurality of layers of material with compliant interfaces, and wherein the compliant interfaces are each less than about 1 millimeter thick.

In certain exemplary embodiments the flowpath surface of the flowpath wall is a leading edge surface.

In certain exemplary embodiments the leading edge surface is a leading edge of the ducting assembly.

In certain exemplary embodiments, the hypersonic propulsion engine further includes a thermal transport bus having a thermal fluid including a one or more heat sink exchangers and one or more heat source exchangers.

In certain exemplary embodiments the thermal fluid is fuel.

In certain exemplary embodiments the thermal fluid is a phase change fluid, and wherein one of the heat sink exchangers is an ambient heat sink exchanger.

In certain exemplary embodiments the thermal fluid is fuel, and wherein the fuel is configured to change phases during operation.

In certain exemplary embodiments, the hypersonic propulsion engine further includes a fuel delivery system having a fuel tank, and wherein one of the heat sink exchangers of the thermal transport bus is incorporated into, or otherwise thermally coupled to, the fuel tank.

In certain exemplary embodiments, the hypersonic propulsion engine further includes a flowpath wall defining a flowpath surface exposed to substantially hypersonic airflow during operation of the hypersonic propulsion engine, wherein the portion of the flowpath wall defining the flowpath surface is formed at least partially of a sacrificial material.

In certain exemplary embodiments, the hypersonic propulsion engine further includes a quick mount structure for mounting the flowpath wall, wherein the quick mount structure is configured to facilitate a quick removal and replacement of the flowpath wall between operations of the hypersonic propulsion engine.

In an exemplary aspect of the present disclosure, a method is provided for operating a hypersonic propulsion engine. The method includes operating the hypersonic propulsion engine in a hypersonic flight operating mode, wherein operating the hypersonic propulsion engine in the hypersonic flight operating mode includes: receiving an inlet airflow through an inlet of a ducting assembly of the hypersonic propulsion engine at an airflow speed greater than about Mach 4 and at a temperature greater than about 1400 degrees Fahrenheit; providing a first portion of the inlet airflow received through the inlet of the ducting assembly through a turbine engine inlet of a turbine engine; providing a second portion of the inlet airflow received through the inlet of the ducting assembly through a bypass duct of a ducting assembly; and reducing a temperature of the inlet airflow at a location upstream of the turbine engine inlet, of the first portion of the inlet airflow through the turbine engine inlet, of the second portion of the inlet airflow through the bypass duct, or a combination thereof by at least about 150 degrees Fahrenheit using a heat exchanger.

In certain exemplary aspects receiving the inlet airflow through the inlet of the ducting assembly includes receiving the airflow through the inlet of the ducting assembly at an airflow speed up to about Mach 6 and at a temperature up to about 3000 degrees Fahrenheit.

In certain exemplary aspects reducing the temperature of the inlet airflow at the location upstream of the turbine engine inlet, of the first portion of the inlet airflow through the turbine engine inlet, of the second portion of the inlet airflow through the bypass duct, or a combination thereof includes reducing the temperature of the inlet airflow at the location upstream of the turbine engine inlet.

In certain exemplary aspects reducing the temperature of the inlet airflow at the location upstream of the turbine engine inlet, of the first portion of the inlet airflow through the turbine engine inlet, of the second portion of the inlet airflow through the bypass duct, or a combination thereof includes reducing the temperature of the inlet airflow through the turbine engine inlet in a turbine engine precooler duct upstream of a compressor section of the turbine engine.

In certain exemplary aspects reducing the temperature of the inlet airflow at the location upstream of the turbine engine inlet, of the first portion of the inlet airflow through the turbine engine inlet, of the second portion of the inlet airflow through the bypass duct, or a combination thereof includes reducing the temperature of the first portion of the inlet airflow through the turbine engine inlet using an intercooler.

In certain exemplary aspects the hypersonic propulsion engine includes a fan located upstream of the turbine engine inlet, wherein the fan is drivingly coupled to a turbine of the turbine engine, and wherein reducing the temperature of the inlet airflow at the location upstream of the turbine engine inlet, of the first portion of the inlet airflow through the turbine engine inlet, of the second portion of the inlet airflow through the bypass duct, or a combination thereof includes reducing the temperature of the inlet airflow at a location upstream of the fan using an inlet precooler.

In certain exemplary aspects a ratio of the second portion of air to the first portion of air is between about 1:1 and about 20:1 while operating the hypersonic propulsion engine in the hypersonic flight operating mode.

In certain exemplary aspects operating the hypersonic propulsion engine in the hypersonic flight operating mode further includes rotating the turbine engine at a rotational speed of at least about 10,000 revolutions per minute.

In certain exemplary aspects operating the hypersonic propulsion engine in the hypersonic flight operating mode further includes: providing the second portion of the inlet airflow from the bypass duct to an afterburning chamber; and increasing a temperature, a pressure, an airflow speed, or a combination thereof of the second portion of the inlet airflow using an augmenter.

In certain exemplary aspects the augmenter is a rotating detonation combustor, and wherein increasing the temperature, the pressure, the airflow speed, or a combination thereof of the second portion of the inlet airflow includes providing a fuel flow through the rotating detonation combustor in a non-asymmetrical manner.

In certain exemplary aspects the bypass duct includes a dual stream section, wherein the dual stream section includes an inner bypass duct stream and an outer bypass duct stream, wherein the inner bypass duct stream and the outer bypass duct stream are in a parallel flow configuration, and wherein a ratio of airflow between the outer bypass duct and inner bypass duct while operating the hypersonic propulsion engine in the hypersonic flight operating mode is between 2:1 and 100:1.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a hypersonic aircraft in accordance with an exemplary embodiment of the present disclosure.

FIG. 2 is a cross-sectional, schematic view of a hypersonic aircraft engine in accordance with an exemplary embodiment of the present disclosure.

FIG. 3 is a close-up, cross-sectional, schematic view of the exemplary hypersonic aircraft engine of FIG. 2.

FIG. 4 is a schematic, axial view of a rotating detonation combustor in accordance with an exemplary embodiment of the present disclosure.

FIG. 5 is a close-up, cross-sectional, schematic view of a hypersonic aircraft engine in accordance with another exemplary embodiment of the present disclosure.

FIG. 6 is a close-up, cross-sectional, schematic view of a hypersonic aircraft engine in accordance with yet another exemplary embodiment of the present disclosure.

FIG. 7 is a close-up, cross-sectional, schematic view of a hypersonic aircraft engine in accordance with still another exemplary embodiment of the present disclosure.

FIG. 8 is a close-up, cross-sectional, schematic view of a hypersonic aircraft engine in accordance with yet another exemplary embodiment of the present disclosure.

FIG. 9 is a close-up, cross-sectional, schematic view of a flowpath wall in accordance with an exemplary embodiment of the present disclosure.

FIG. 10 is a close-up, cross-sectional, schematic view of a flowpath wall in accordance with another exemplary embodiment of the present disclosure.

FIG. 11 is a close-up, cross-sectional, schematic view of a flowpath wall in accordance with yet another exemplary embodiment of the present disclosure.

FIG. 12 is a close-up, cross-sectional, schematic view of a hypersonic aircraft engine in accordance with still another exemplary embodiment of the present disclosure.

FIG. 13 is a close-up, cross-sectional, schematic view of a hypersonic aircraft engine in accordance with yet another exemplary embodiment of the present disclosure.

FIG. 14 is a flow diagram of a method of operating a hypersonic aircraft engine in accordance with an embodiment of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

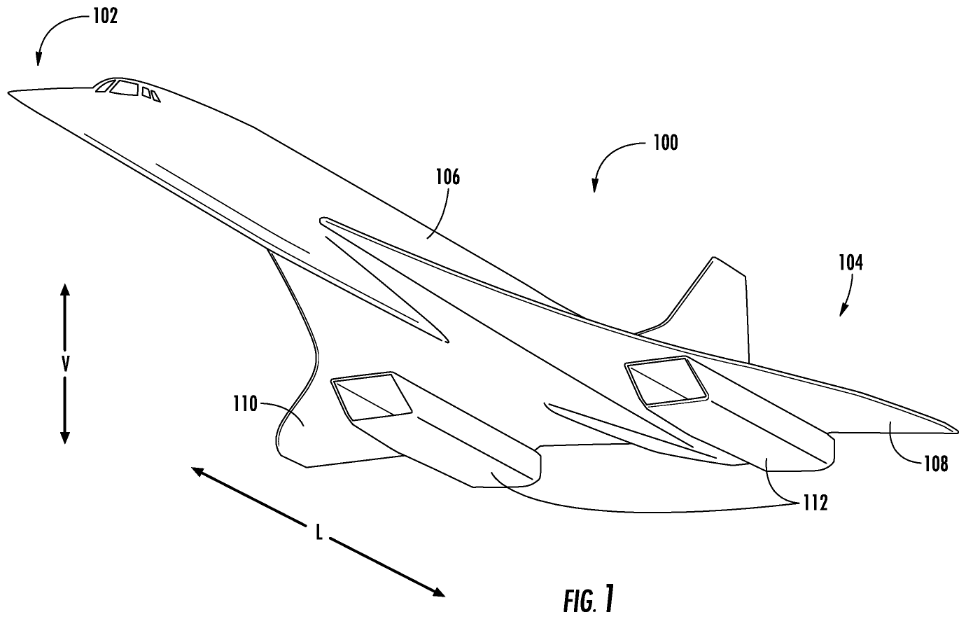

Referring now to the drawings, wherein identical numerals indicate the same elements throughout the Figs., FIG. 1 provides a perspective view of a hypersonic aircraft 100 in accordance with an exemplary aspect of the present disclosure. The exemplary hypersonic aircraft 100 of FIG. 1 generally defines a vertical direction V, a lateral direction (not labeled), and a longitudinal direction L. Moreover, the hypersonic aircraft 100 extends between a forward end 102 and aft end 104 generally along the longitudinal direction L. For the embodiment shown, the hypersonic aircraft 100 includes a fuselage 106, a first wing 108 extending from a port side of the fuselage 106, and second wing 110 extending from a starboard side of the fuselage 106, and a vertical stabilizer. The hypersonic aircraft 100 includes a propulsion system, which for the embodiment shown includes a pair of hypersonic propulsion engines 112, with a first of such engines 112 mounted beneath the first wing 108 and a second of such engines 112 mounted beneath the second wing 110. As will be appreciated, the propulsion system may be configured for propelling the hypersonic aircraft 100 from takeoff (e.g., 0 miles per hour up to around 250 miles per hour) up and to hypersonic flight. It will be appreciated, that as used herein, the term “hypersonic” refers generally to air speeds of about Mach 4 up to about Mach 10, such as Mach 5 and up.

Notably, the exemplary hypersonic aircraft 100 depicted in FIG. 1 is provided by way of example only, and in other embodiments may have any other suitable configuration. For example, in other embodiments, the fuselage 106 may have any other suitable shape (such as a more pointed, aerodynamic shape, different stabilizer shapes and orientation, etc.), the propulsion system may have any other suitable engine arrangement (e.g., an engine incorporated into the vertical stabilizer), any other suitable configuration, etc.

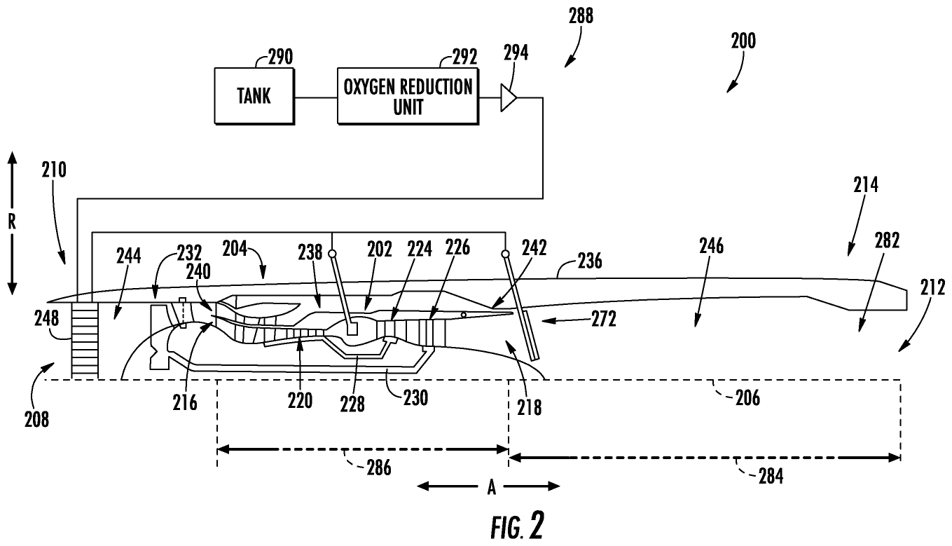

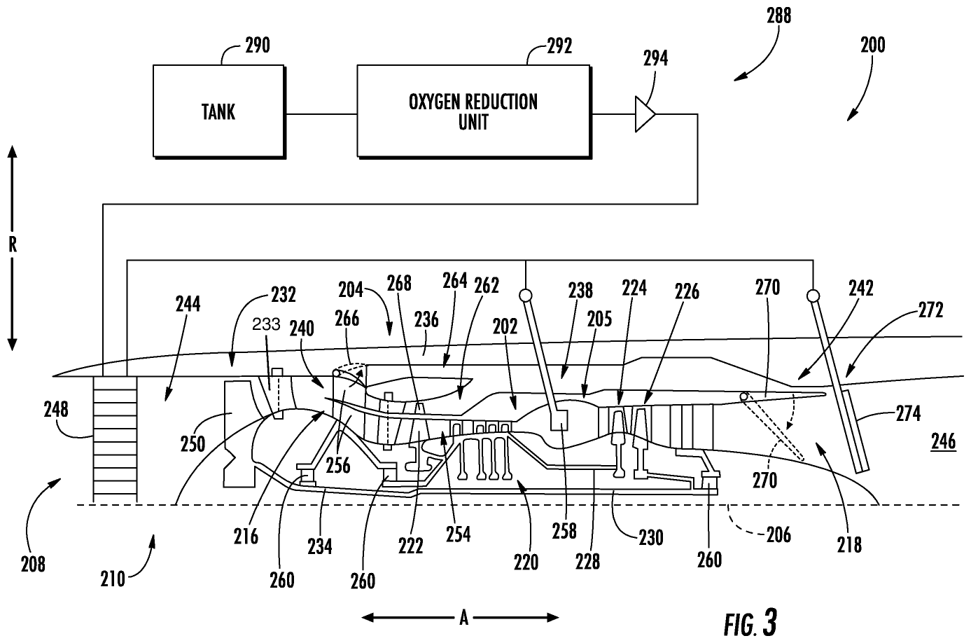

Referring now to FIGS. 2 and 3, cross-sectional views of a hypersonic propulsion engine 200 in accordance with an exemplary aspect of the present disclosure are provided. As will be appreciated, the exemplary hypersonic propulsion engine 200 depicted generally includes a turbine engine 202 and a ducting assembly 204. FIG. 2 provides a cross-sectional view of an entire length of the turbine engine 202 (showing all of the ducting assembly 204), and FIG. 3 provides a close-up view of a portion of the ducting assembly 204 and the turbine engine 202. Notably, the hypersonic propulsion engine 200 may be incorporated into a hypersonic aircraft (such as the hypersonic aircraft 100 of FIG. 1 as engine 112).

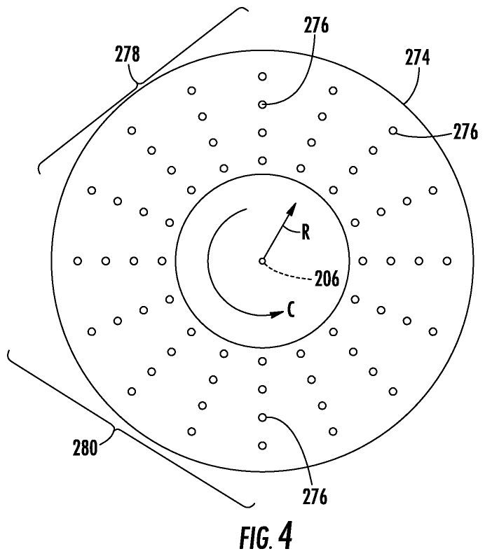

The exemplary hypersonic propulsion engine 200 depicted generally defines an axial direction A (with a longitudinal centerline 206 extending along the axial direction A), a radial direction R, and a circumferential direction C (extending about the axial longitudinal centerline 206, see FIG. 4). Additionally, the hypersonic propulsion engine 200 defines an engine inlet 208 at a forward end 210 along the axial direction A and an engine exhaust 212 at an aft end 214 along the axial direction A (FIG. 2).

Referring first particularly to the exemplary turbine engine 202, it will be appreciated that the exemplary turbine engine 202 depicted defines a turbine engine inlet 216 and a turbine engine exhaust 218. Further, the exemplary turbine engine 202 includes a compressor section, a combustion section 205, and a turbine section arranged in serial flow order. The compressor section includes a first compressor 220 having a plurality of sequential stages of compressor rotor blades (including a forward-most stage of compressor rotor blades 222; FIG. 3). Similarly, the turbine section includes a first turbine 224, and further includes a second turbine 226. The first turbine 224 is a high speed turbine coupled to the first compressor 220 through a first engine shaft 228. In such a manner, the first turbine 224 may drive the first compressor 220 of the compressor section. The second turbine 226 is a low speed turbine coupled to a second engine shaft 230.

As will also be appreciated, for the embodiment shown, the hypersonic propulsion engine 200 further includes a fan 232. The fan 232 is located forward (and upstream) of the turbine engine inlet 216. Moreover, the fan 232 includes a fan shaft 234, which for the embodiment shown is coupled to, or formed integrally with the second engine shaft 230, such that the second turbine 226 of the turbine section of the turbine engine 202 may drive the fan 232 during operation of the hypersonic propulsion engine 200. The engine 200 further includes a plurality of outlet guide vanes 233, which for the embodiment depicted are variable outlet guide vanes (configured to pivot about a rotational pitch axis (shown in phantom). The variable outlet guide vanes may further act as struts. Regardless, the variable outlet guide vanes 233 may enable the fan 232 to run at variable speeds and still come out with relatively straight air flow. In other embodiments, the outlet guide vanes 233 may instead be fixed-pitch guide vanes.

Referring still to FIGS. 2 and 3, the ducting assembly 204 generally includes an outer case 236 and defines a bypass duct 238, the outer case 236 and bypass duct 238 extending around the turbine engine 202. The bypass duct 238 may have a substantially annular shape extending around the turbine engine 202, such as substantially 360 degrees around the turbine engine 202. Moreover, for the embodiment shown, the bypass duct 238 extends between a bypass duct inlet 240 and a bypass duct exhaust 242. The bypass duct inlet 240 is aligned with the turbine engine inlet 216 for the embodiment shown, and the bypass duct exhaust 242 is aligned with the turbine engine exhaust 218 for the embodiment shown.

Moreover, for the embodiment shown, the ducting assembly 204 further defines an inlet section 244 located at least partially forward of the bypass duct 238 and an afterburning chamber 246 located downstream of the bypass duct 238 and at least partially aft of the turbine engine exhaust 218. Referring particularly to the inlet section 244, for the embodiment shown, the inlet section 244 is located forward of the bypass duct inlet 240 and the turbine engine inlet 216. Moreover, for the embodiment shown, the inlet section 244 extends from the hypersonic propulsion engine inlet 208 to the turbine engine inlet 216 and bypass duct inlet 240. By contrast, the afterburning chamber 246 extends from the bypass duct exhaust 242 and turbine engine exhaust 218 to the hypersonic propulsion engine exhaust 212 (FIG. 2).

Referring still to FIGS. 2 and 3, the hypersonic propulsion engine 200 depicted further includes an inlet precooler 248 positioned at least partially within the inlet section 244 of the ducting assembly 204 and upstream of the turbine engine inlet 216, the bypass duct 238, or both (and more particularly, upstream of both for the embodiment shown). As will be discussed in greater detail below, the inlet precooler 248 is generally provided for cooling an airflow through the inlet section 244 of the ducting assembly 204 to the turbine engine inlet 216, the bypass duct 238, or both.

During operation of the hypersonic propulsion engine 200, an inlet airflow is received through the hypersonic propulsion engine inlet 208. The inlet airflow passes through the inlet precooler 248, reducing a temperature of the inlet airflow. The inlet airflow then flows into the fan 232. As will be appreciated, the fan 232 generally includes a plurality of fan blades 250 rotatable by the fan shaft 234 (and second engine shaft 230). The rotation of the fan blades 250 of the fan 232 increases a pressure of the inlet airflow. For the embodiment shown, the hypersonic propulsion engine 200 further includes at stage of guide vanes 252 located downstream of the plurality of fan blades 250 of the fan 232 and upstream of the turbine engine inlet 216 (and bypass duct inlet 240). For the embodiment shown, the stage of guide vanes 252 is a stage of variable guide vanes, each rotatable about its respective axis. The guide vanes 252 may change a direction of the inlet airflow from the plurality of fan blades 250 of the fan 232. From the stage guide vanes 252, a first portion of the inlet airflow flows through the turbine engine inlet 216 and along a core air flowpath 254 of the turbine engine 202, and a second portion of the inlet airflow flows through the bypass duct 238 of the ducting assembly 204, as will be explained in greater detail below. Briefly, it will be appreciated that the exemplary hypersonic propulsion engine 200 includes a forward frame, the forward frame including a forward frame strut 256 (and more specifically a plurality of circumferentially spaced forward frame struts 256) extending through bypass duct 238 proximate the bypass duct inlet 240 and through the core air flowpath 254 of the turbine engine 202 proximate the turbine engine inlet 216.

Generally, the first portion of air passes through the first compressor 220, wherein a temperature and pressure of such first portion of air is increased and provided to the combustion section 205. The combustion section 205 includes a plurality of fuel nozzles 258 spaced along the circumferential direction C for providing a mixture of compressed air and fuel to a combustion chamber of the combustion section 205. The compressed air and fuel mixture is combusted to generate combustion gases, which are provided through the turbine section. The combustion gases are expanded across the first turbine 224 and second turbine 226, driving the first turbine 224 (and first compressor 220 through the first engine shaft 228) and the second turbine 226 (and fan 232 through the second engine shaft 230). The combustion gases are then exhausted through the turbine engine exhaust 218 and provided to the afterburning chamber 246 of the ducting assembly 204.

As is depicted schematically, the hypersonic propulsion engine 200, and in particular, the turbine engine 202, includes a plurality of bearings 260 for supporting one or more rotating components of the hypersonic propulsion engine 200. For example, the exemplary hypersonic propulsion engine 200/turbine engine 202 depicted includes one or more bearings 260 supporting the first engine shaft 228 and the second engine shaft 230. For the embodiment shown, the one or more bearings 260 are configured as air bearings. Example air bearings that may be used include, but are not limited to, the air bearings described in U.S. Pat. No. 8,083,413 issued Dec. 27, 2011; U.S. Pat. No. 8,100,586 issued Jan. 24, 2012; U.S. Pat. No. 9,169,846 issued Oct. 27, 2015; U.S. Pat. No. 9,429,191 issued Aug. 30, 2016; U.S. Pat. No. 9,416,820 issued Aug. 16, 2016; U.S. Pat. No. 9,482,274 issued Nov. 1, 2016; and U.S. Pat. No. 10,066,505 issued Sep. 4, 2018, and each of which is incorporated herein fully by reference for all purposes.

It will be appreciated, however, that in other exemplary embodiments, the one or more bearings 260 may be formed in any other suitable manner. For example, in other embodiments, one or more of the bearings 260 may be roller bearings, ball bearings, etc.

Referring still to FIGS. 2 and 3, the second portion of the inlet airflow, as noted above, is provided through the bypass duct 238. Notably, for the embodiment shown, the bypass duct 238 includes a dual stream section. The dual stream section includes an inner bypass stream 262 and an outer bypass stream 264. The inner bypass stream 262 and outer bypass stream 264 are in a parallel flow configuration and, for the embodiment shown, extend at least partially outward of the first compressor 220 of the compressor section of the turbine engine 202. Notably, for the embodiment shown, the ducting assembly 204 includes an outer bypass stream door 266 located at an upstream end of the outer bypass duct stream 264. The outer bypass duct stream door 266 is movable between a closed position (shown) and an open position (depicted in phantom). The outer bypass stream door 266 substantially completely blocks the outer bypass stream 264 when in the closed position, such that substantially all of the second portion of the inlet airflow received through the bypass duct 238 flows through the inner bypass stream 262. By contrast, the outer bypass stream door 266 allows airflow through the outer bypass stream 264 when in the open position. Notably, the ducting assembly 204 is designed aerodynamically such that when the outer bypass stream door 266 is in the open position during hypersonic flight operating conditions, a ratio of an amount of airflow through the outer bypass duct stream 264 to an amount of airflow through the inner bypass duct 262 stream is greater than 1:1, such as greater than about 2:1, such as greater than about 4:1, and less than about 100:1, such as less than about 10:1.

Referring still to the dual stream section, and more particularly to the inner bypass stream 262, it will be appreciated that for the embodiment shown the ducting assembly 204 further includes a stage of airfoils 268 positioned at least partially within the inner bypass stream 262. More particularly, for the embodiment shown, each compressor rotor blade of the forward-most stage of compressor rotor blades 222 of the first compressor 220 of the turbine engine 202 defines a radially outer end. The stage of airfoils 268 of the ducting assembly 204 is coupled to the forward-most stage of compressor rotor blades 222 at the radially outer ends. In such a manner, the stage of airfoils 268 is configured to be driven by, and rotate with the first compressor 220 during at least certain operations. For the embodiment shown, the stage of airfoils 268 of the ducting assembly 204 is a stage of compression airfoils configured to compress the second portion of air flowing through the inner bypass duct stream 262, increasing a pressure and/or flowrate of such airflow.

Downstream of the dual stream section of the bypass duct 238, the second portion of the inlet airflow is merged back together and flows generally along the axial direction A to the bypass duct exhaust 242. For the embodiment shown, the airflow through the bypass duct 238 is merged with the exhaust gases of the turbine engine 202 at the afterburning chamber 246. The exemplary hypersonic propulsion engine 200 depicted includes a bypass airflow door 270 located at the turbine engine exhaust 218 and bypass duct exhaust 242. The bypass airflow door 270 is movable between an open position (shown) wherein airflow through the core air flowpath 254 of the turbine engine 202 may flow freely into the afterburning chamber 246, and a closed position (depicted in phantom), wherein airflow from the bypass duct 238 may flow freely into the afterburning chamber 246. Notably, the bypass airflow door 270 may further be movable between various positions therebetween to allow for a desired ratio of airflow from the turbine engine 202 to airflow from the bypass duct 238 into the afterburning chamber 246.

During certain operations, such as during hypersonic flight operations, further thrust may be realized from the airflow into and through the afterburning chamber 246. More specifically, for the embodiment shown, the hypersonic propulsion engine 200 further includes an augmenter 272 positioned at least partially within the afterburning chamber 246. Particularly, for the embodiment shown, the augmenter 272 is positioned at an upstream end of the afterburning chamber 246, and more particularly, immediately downstream of the bypass duct exhaust 242 and turbine engine exhaust 218.

Notably, for the embodiment shown, the afterburning chamber 246 is configured as a hyperburner chamber, and the augmenter 272 incorporates a rotating detonation combustor 274. Exemplary rotating detonation combustors 274 that may be incorporated into the augmenter 272 in the exemplary hypersonic propulsion engine 200 depicted include the systems disclosed in U.S. Patent App. Pub. No. 2018/0231256 filed Feb. 10, 2017; U.S. Patent App. Pub. No. 2018/0356094 filed Jun. 9, 2017; U.S. Patent App. Pub. No. 2018/03356099 filed Jun. 9, 2017; U.S. Patent App. Pub. No. 2018/0355792 filed Jun. 9, 2017; U.S. Patent App. Pub. No. 2018/0355795 filed Jun. 9, 2017, and each of which is incorporated herein fully by reference for all purposes.

More particularly, referring briefly to FIG. 4, providing an aft looking forward view of the exemplary rotating detonation combustor 274 of FIGS. 2 and 3 along the longitudinal centerline 206, the exemplary rotating detonation combustor 274 defines a plurality of fuel holes 276 arranged along the circumferential direction C. More particularly, the plurality of fuel holes 276 of the exemplary rotating detonation combustor 274 includes a first set 278 of fuel holes 276 and a second set 280 of fuel holes 276. For the embodiment shown, the first set 278 of fuel holes 276 are configured to introduce more fuel to the afterburning chamber 246 per individual fuel hole 276 than the second set 280 of fuel holes 276 per individual fuel hole 276 (such as, e.g., 10% more, 20% more, 50% more 100% more, or up to 1000% more). As such, the rotating detonation combustor 274 may be configured to provide a varying amount of fuel along the circumferential direction C. Notably, the space between the fuel holes 276 may allow for a free flow of air.

Further, referring back to FIGS. 2 and 3, and particularly to FIG. 2, it will be appreciated that the afterburning chamber 246 extends generally to the hypersonic propulsion engine exhaust 212, defining a nozzle outlet 282 at the hypersonic propulsion engine exhaust 212. Moreover, the afterburning chamber 246 defines an afterburning chamber axial length 284 between the turbine engine exhaust 218 and the hypersonic propulsion engine exhaust 212. Similarly, the turbine engine 202 defines a turbine engine axial length 286 between the turbine engine inlet 216 and the turbine engine exhaust 218. For the embodiment depicted, the afterburning chamber axial length 284 is at least about fifty percent of the turbine engine axial length 286 and up to about 500 percent of the turbine engine axial length 286. More particularly, for the embodiment shown, the afterburning chamber axial length 284 is greater than the turbine engine axial length 286. For example, in certain embodiments, the afterburning chamber 246 may define an afterburning chamber axial length 284 that is at least about 125 percent of the turbine engine axial length 286, such as at least about 150 percent of the turbine engine 202. However, in other embodiments (such as embodiments incorporating the rotating detonation combustor 274), the afterburning chamber axial length 284 may be less than the turbine engine axial length 286.

Moreover, it will be appreciated that in at least certain exemplary embodiments, the hypersonic propulsion engine 200 may include one or more components for varying a cross-sectional area of the nozzle outlet 282. As such, the nozzle outlet 282 may be a variable geometry nozzle outlet configured to change in cross-sectional area based on e.g., one or more flight operations, ambient conditions, etc.

Referring particularly to FIG. 3, as noted above, the hypersonic propulsion engine 200 includes the inlet precooler 248 position at least partially within the inlet section 244 of the ducting assembly 204 upstream of the turbine engine inlet 216, the bypass duct 238, or both for cooling the inlet airflow provided through the inlet section 244 to the turbine engine inlet 216 the bypass duct 238, or both. During hypersonic flight operations, the inlet airflow received through the inlet section 244 may be at a relatively high temperature due at least in part to one or more hypersonic shock waves generated. For example the inlet airflow received through the inlet section 244 may be at a temperature greater than or equal to about 1000 degrees Fahrenheit, such as greater than equal to about 1500 degrees Fahrenheit, such as up to about 3000 degrees Fahrenheit. A turbine engine may not be able to function as desired receiving airflow at such temperatures. As such, including the inlet precooler 248 may allow for operation of the hypersonic propulsion engine 200 at such operating conditions by reducing the temperature of the inlet airflow provided through the inlet section 244 of the hypersonic propulsion engine 200. For example, the inlet precooler 248 may be configured to reduce a temperature of the inlet airflow through the inlet section 244 of the ducting assembly 204 during hypersonic flight operations by at least about one hundred and fifty (150) degrees Fahrenheit, such as by at least about three hundred (300) degrees Fahrenheit, such as by at least about four hundred (400) degrees Fahrenheit, such as up to about 1,000 degrees Fahrenheit. Such may accordingly enable, at least in part, operation of the hypersonic propulsion engine 200 at such hypersonic flight operating conditions.

For the embodiment shown, it will be appreciated that the exemplary hypersonic propulsion engine 200 further includes a fuel delivery system 288. The fuel delivery system 288 is configured for providing a flow fuel to the combustion section 205 of the turbine engine 202, and for the embodiment shown, the augmenter 272 positioned at least partially within the afterburning chamber 246. The exemplary fuel delivery system 288 depicted generally includes a fuel tank 290 and a fuel oxygen reduction unit 292. The fuel oxygen reduction unit 292 may be configured to reduce an oxygen content of the fuel flow from the fuel tank 290 and through the fuel delivery system 288. For example, the fuel oxygen reduction unit 292 depicted in FIG. 3 may be configured in a similar manner to one or more the exemplary fuel oxygen reduction units described in U.S. Pat. No. 7,459,081 issued Dec. 2, 2008; and U.S. Patent App. Publication No. 20120216677, published Aug. 30, 2012, and each of which is incorporated herein fully by reference for all purposes.

The fuel delivery system 288 further includes a fuel pump 294 configured to increase a pressure of the fuel flow through the fuel delivery system 288. Further, for the embodiment shown the inlet precooler 248 is a fuel-air heat exchanger thermally coupled to the fuel delivery system 288. More specifically, for the embodiment shown, the inlet precooler 248 is configured to utilize fuel directly as a heat exchange fluid, such that heat extracted from the inlet airflow through the inlet section 244 of the ducting assembly 204 is transferred to the fuel flow through the fuel delivery system 288. For the embodiment shown, the heated fuel (which may increase in temperature by an amount corresponding to an amount that the inlet airflow temperature is reduced by the inlet precooler 248, as discussed above) is then provided to the combustion section 205 and/or the augmenter 272. Notably, in addition to acting as a relatively efficient heat sink, increasing a temperature of the fuel prior to combustion may further increase an efficiency of the hypersonic propulsion engine 200.

Further, it will be appreciated that the hypersonic propulsion engine may further include additional features for enabling at least in part operation of the hypersonic propulsion engine 200 at such hypersonic flight operating conditions. One or more of these additional features are described in the Parts below.

Part B: Fan

Further, it will be appreciated that the above-described hypersonic propulsion engine 200 may further include additional features for enabling at least in part operation of the hypersonic propulsion engine 200 at such hypersonic flight operating conditions. For example, for the embodiment shown, the fan 232 is located downstream of the inlet precooler 248. However, despite this, the fan 232, and more particularly, the plurality of fan blades 250 of the fan 232, may be exposed relatively high temperatures during hypersonic flight operations. In order to allow for the plurality of fan blades 250 of the fan 232 to withstand such relatively high temperatures, each of the plurality of fan blades 250 are formed of a certain matrix composite material for the embodiment shown.

Notably, as used herein, ceramic matrix composite (CMC) material refers to a non-metallic material having high temperature capability. Exemplary CMC materials utilized for such components may include silicon carbide (SiC), silicon nitride, or alumina matrix materials and combinations thereof. Ceramic fibers may be embedded within the matrix, such as oxidation stable reinforcing fibers including monofilaments like sapphire and silicon carbide (e.g., Textron's SCS-6), as well as roving and yarn including silicon carbide (e.g., Nippon Carbon's NICALON®, Ube Industries' TYRANNO®, and Dow Corning's SYLRAMIC®), alumina silicates (e.g., Nextel's 440 and 480), and chopped whiskers and fibers (e.g., Nextel's 440 and SAFFIL®), and optionally ceramic particles (e.g., oxides of Si, Al, Zr, Y, and combinations thereof) and inorganic fillers (e.g., pyrophyllite, wollastonite, mica, talc, kyanite, and montmorillonite). For example, in certain embodiments, bundles of the fibers, which may include a ceramic refractory material coating, are formed as a reinforced tape, such as a unidirectional reinforced tape. A plurality of the tapes may be laid up together (e.g., as plies) to form a preform component. The bundles of fibers may be impregnated with a slurry composition prior to forming the preform or after formation of the preform. The preform may then undergo thermal processing, such as a cure or burn-out to yield a high char residue in the preform, and subsequent chemical processing, such as melt-infiltration with silicon, to arrive at a component formed of a CMC material having a desired chemical composition. In other embodiments, the CMC material may be formed as, e.g., a carbon fiber cloth rather than as a tape.

Moreover, in certain embodiment other components of the hypersonic propulsion engine 200 may be formed of CMC material. For example, various components within the turbine engine 202 exposed to the core air flowpath 254, and particularly those components within the turbine section of the turbine engine 202, may be formed of a CMC material. For example, the compressor and/or turbine rotor blades, fan blades, stator vanes, liners, shrouds, ducts, nacelles, struts, etc. within the turbine engine 202, or elsewhere, may be formed of a CMC material.

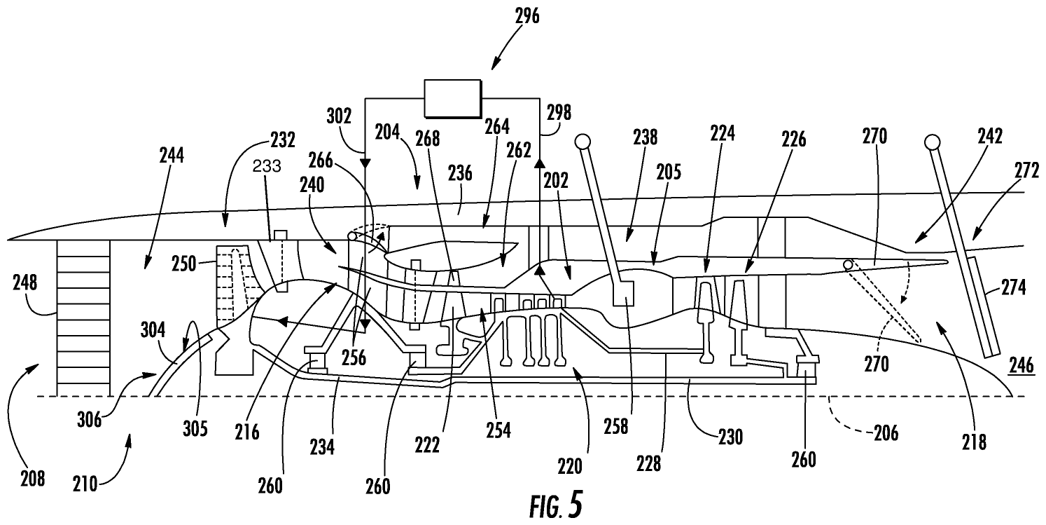

Referring again to the fan 232, additionally, or alternatively, it will be appreciated that in other embodiments, the hypersonic propulsion engine 200 may include other features for enabling operation of the fan 232, including the plurality of fan blades 250, at the relatively high operating temperatures present during hypersonic flight operations. For example, reference will now be made briefly to FIG. 5, providing a cross-sectional view of a hypersonic propulsion engine 200 in accordance with another exemplary embodiment of the present disclosure. The exemplary hypersonic propulsion engine 200 of FIG. 5 may be configured in substantially the same manner as the exemplary hypersonic propulsion engine 200 of FIG. 3, and accordingly, the same or similar numbers may refer to the same or similar part.

By contrast to the exemplary hypersonic propulsion engine 200 of FIG. 3, for the embodiment depicted in FIG. 5, the plurality of fan blades 250 of the fan 232 are actively cooled fan blades. More specifically, the turbine engine 202 of the exemplary hypersonic propulsion engine 200 of FIG. 5 defines a cooling duct 296 for providing a cooling fluid therethrough. More specifically, the hypersonic propulsion engine 200 includes a first duct 298 for receiving a bleed airflow from the compressor section of the turbine engine 202, a heat exchanger 300 for reducing a temperature of the bleed airflow, and a second duct 302 extending through the forward frame strut 256, to a location inward of the core air flowpath 254 of the turbine engine 202, and forward to the plurality of fan blades 250 of the fan 232. In such a manner, it will be appreciated that the plurality of fan blades 250 of the fan 232 are in fluid communication with the cooling duct 296, or rather, the second duct 302, for receiving at least a portion of the cooling fluid, which for the embodiment depicted is a cooled compressor bleed airflow, for cooling the plurality of fan blades 250. As is depicted schematically, the cooling fluid provided to the fan blades 250 may circulate through the fan blades 250 and/or exit through one or more cooling holes in the fan blades 250, such as film cooling holes, for reducing a temperature of such fan blades 250.

Notably, with such an exemplary embodiment, the plurality of fan blades 250 may be formed of a metal, such as a high temperature metal alloy capable of withstanding the relatively high operating temperatures during hypersonic flight operations, with the assistance of the active cooling depicted in the embodiment of FIG. 5. Alternatively, the fan blades 250 may be formed of a CMC material.

Alternatively, still, in accordance with certain aspects of the present subject matter, fan blades 250 may be formed using an additive-manufacturing process, such as a 3-D printing process. The use of such a process may allow fan blades 250 to be formed integrally, as a single monolithic component, or as any suitable number of sub-components. In particular, the manufacturing process may allow fan blades 250 to be integrally formed and include a variety of features not possible when using prior manufacturing methods. For example, the additive manufacturing methods described herein enable the manufacture of fan blades 250 having unique features, configurations, thicknesses, materials, densities, fluid passageways, headers, and mounting structures not possible using prior manufacturing methods. In particular, the additive manufacturing methods described herein may enable the fan blades 250 to be formed with the cooling channels, cooling holes, etc. described above.

As used herein, the terms “additively manufactured” or “additive manufacturing techniques or processes” refer generally to manufacturing processes wherein successive layers of material(s) are provided on each other to “build-up,” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets, laser jets, and binder jets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be metal, concrete, ceramic, polymer, epoxy, photopolymer resin, or any other suitable material that may be in solid, liquid, powder, sheet material, wire, or any other suitable form or combinations thereof. More specifically, according to exemplary embodiments of the present subject matter, the additively manufactured components described herein may be formed in part, in whole, or in some combination of materials including but not limited to pure metals, nickel alloys, chrome alloys, titanium, titanium alloys, magnesium, magnesium alloys, aluminum, aluminum alloys, and nickel or cobalt based superalloys (e.g., those available under the name Inconel® available from Special Metals Corporation). These materials are examples of materials suitable for use in the additive manufacturing processes described herein, and may be generally referred to as “additive materials.”

In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

An exemplary additive manufacturing process will now be described. Additive manufacturing processes fabricate components using three-dimensional (3D) information, for example a three-dimensional computer model, of the component. Accordingly, a three-dimensional design model of the component may be defined prior to manufacturing. In this regard, a model or prototype of the component may be scanned to determine the three-dimensional information of the component. As another example, a model of the component may be constructed using a suitable computer aided design (CAD) program to define the three-dimensional design model of the component.

The design model may include 3D numeric coordinates of the entire configuration of the component including both external and internal surfaces of the component. For example, the design model may define the body, the surface, and/or internal passageways such as openings, support structures, etc. In one exemplary embodiment, the three-dimensional design model is converted into a plurality of slices or segments, e.g., along a central (e.g., vertical) axis of the component or any other suitable axis. Each slice may define a thin cross section of the component for a predetermined height of the slice. The plurality of successive cross-sectional slices together form the 3D component. The component is then “built-up” slice-by-slice, or layer-by-layer, until finished.

In this manner, the components described herein may be fabricated using the additive process, or more specifically each layer is successively formed, e.g., by fusing or polymerizing a component material using laser energy or heat or by sintering or melting metal powder. For example, a particular type of additive manufacturing process may use an energy beam, for example, an electron beam or electromagnetic radiation such as a laser beam, to sinter or melt a powder material. Any suitable laser and laser parameters may be used, including considerations with respect to power, laser beam spot size, and scanning velocity. The build material may be formed by any suitable powder or material selected for enhanced strength, durability, and useful life, particularly at high temperatures.

Each successive layer may be, for example, between about 10 μm and 200 μm, although the thickness may be selected based on any number of parameters and may be any suitable size according to alternative embodiments. Therefore, utilizing the additive formation methods described above, the components described herein may have cross sections as thin as one thickness of an associated powder layer, e.g., 10 μm, utilized during the additive formation process.

In addition, utilizing an additive process, the surface finish and features of the components may vary as need depending on the application. For example, the surface finish may be adjusted (e.g., made smoother or rougher) by selecting appropriate laser scan parameters (e.g., laser power, scan speed, laser focal spot size, etc.) during the additive process, especially in the periphery of a cross-sectional layer which corresponds to the part surface. For example, a rougher finish may be achieved by increasing laser scan speed or decreasing the size of the melt pool formed, and a smoother finish may be achieved by decreasing laser scan speed or increasing the size of the melt pool formed. The scanning pattern and/or laser power can also be changed to change the surface finish in a selected area.

While the present disclosure is not limited to the use of additive manufacturing to form these components generally, additive manufacturing does provide a variety of manufacturing advantages, including ease of manufacturing, reduced cost, greater accuracy, etc.

In this regard, utilizing additive manufacturing methods, even multi-part components may be formed as a single piece of continuous metal, and may thus include fewer sub-components and/or joints compared to prior designs. The integral formation of these multi-part components through additive manufacturing may advantageously improve the overall assembly process. For example, the integral formation reduces the number of separate parts that must be assembled, thus reducing associated time and overall assembly costs. Additionally, existing issues with, for example, leakage, joint quality between separate parts, and overall performance may advantageously be reduced.

Also, the additive manufacturing methods described above enable much more complex and intricate shapes and contours of the components described herein. For example, such components may include thin additively manufactured layers and unique fluid passageways. In addition, the additive manufacturing process enables the manufacture of a single component having different materials such that different portions of the component may exhibit different performance characteristics. The successive, additive nature of the manufacturing process enables the construction of these novel features. As a result, the components described herein may exhibit improved functionality and reliability.

Moreover, it will further be appreciated that the exemplary hypersonic propulsion engine 200 depicted in FIG. 5 includes a flowpath wall 304 defining a flowpath surface 305 exposed to substantially hypersonic airflow during operation of the hypersonic propulsion engine 200 in a hypersonic flight operation condition. More specifically, the exemplary hypersonic propulsion engine 200 includes a nosecone, or spinner 306. For the embodiment shown, the flowpath wall 304 is an outer wall of the spinner 306 and the flowpath surface 305 thereof is formed at least partially of a sacrificial material. In such a manner, the flowpath surface 305 of the flowpath wall 304/outer wall of the spinner 306 may be designed to deteriorate during operation of the hypersonic propulsion engine 200 in a hypersonic flight operation. However, the propulsion engine may be configured such that the flowpath wall 304/outer wall of the spinner 306 may be relatively easily replaced in between flight operations or, e.g., after a predetermined amount of time, in response to inspection or some other flight condition, etc. More specifically, the hypersonic propulsion engine 200 may include a quick mount structure for mounting the flowpath wall 304/outer wall of the spinner 306, wherein the quick mount structure is configured to facilitate a quick removal and replacement of the flowpath wall 304/outer wall of the spinner 306 in between operations of the hypersonic propulsion engine 200. The quick mount structure may include one or more rails, pins, etc.

As such, the flowpath wall 304 may be made of a simpler, more lightweight, and/or more cost efficient material, and/or without complicated and expensive cooling assemblies. Notably, however any other suitable flowpath wall 304 may additionally, or alternatively, be made of the sacrificial material. For example, an inner flowpath wall of any of the ducting assembly 204, such as the leading edges of the ducting assembly 204 and/or turbine engine 202, one or more surfaces of the hypersonic aircraft 100 incorporating the hypersonic propulsion engine 200, etc. may include a flowpath surface formed at least partially of a sacrificial material.

Part C: Intercooler

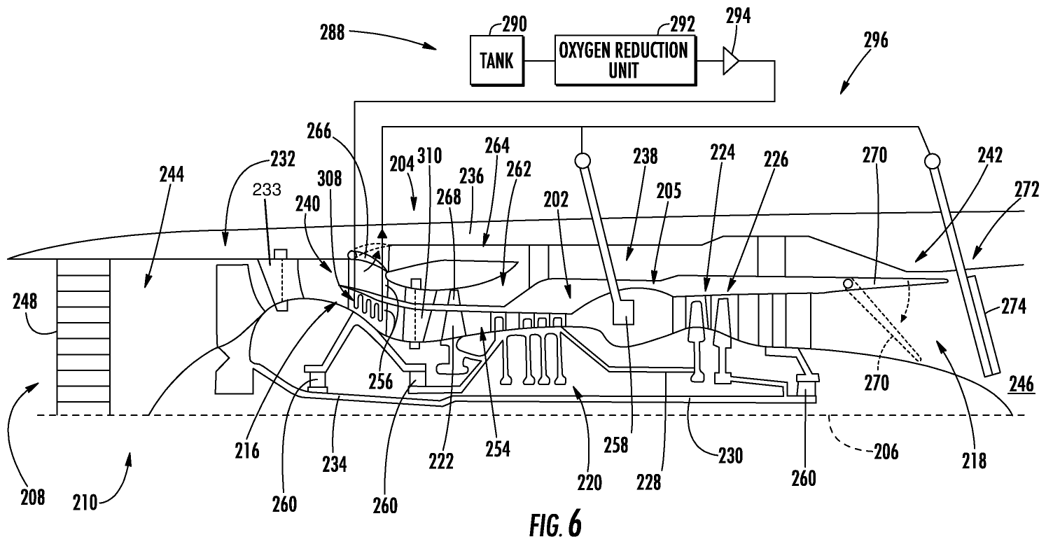

Referring now briefly to FIG. 6, an exemplary hypersonic propulsion engine 200 in accordance with another aspect of the present disclosure is provided. The exemplary hypersonic propulsion engine 200 depicted in FIG. 6 may be configured in substantially the same manner as the exemplary hypersonic propulsion engine 200 described above with reference to FIGS. 2 and 3. However, for the embodiment of FIG. 6, the hypersonic propulsion engine 200 further includes an intercooler 308. More specifically, the turbine engine 202 includes the intercooler 308 integrated into, for the embodiment shown, the forward frame strut 256 of the hypersonic propulsion engine 200. It will be appreciated, however, that in other exemplary embodiments, the intercooler 308 may additionally, or alternatively, be incorporated into one or more of the guide vanes of the turbine engine 202. For example, as is shown, the exemplary turbine engine 202 further includes a stage of guide vanes 310, which for the embodiment shown are variable inlet guide vanes. In certain embodiments, the intercooler 308 may additionally or alternatively, be incorporated into the stage of variable inlet guide vanes 310.

Notably, for the embodiment depicted, the intercooler 308 is thermally coupled to the fuel delivery system 288 of the hypersonic propulsion engine 200. In particular, for the embodiment shown, the intercooler 308 utilizes a fuel flow as a heat exchange fluid. Accordingly, heat extracted from the first portion of the inlet airflow through the core air flowpath 254 of the turbine engine 202 by the intercooler 308 is transferred to the fuel flow. Notably, in certain embodiments, the fuel flow through the fuel delivery system 288 may be similarly utilized as the heat exchange fluid for the inlet precooler 248, as in the embodiment of FIG. 3, described above. In such a configuration, the fuel delivery system 288 may include parallel flows of fuel to the inlet precooler 248 and the intercooler 308, or alternatively, may include such flows in series.

As noted above, during hypersonic flight, the temperature of the inlet airflow may be relatively high, even after passing through the inlet precooler 248, if provided. As such, including the intercooler 308 may allow for operation of the hypersonic propulsion engine 200 at such operating conditions by reducing the temperature of the first portion of the inlet airflow provided through the turbine engine 202. For example, the intercooler 308 may be configured to reduce a temperature of the first portion of the inlet airflow through the turbine engine 202 during hypersonic flight operations by at least about two hundred (200) degrees Fahrenheit, such as by at least about three hundred (300) degrees Fahrenheit, such as by at least about six hundred (600) degrees Fahrenheit, such as up to about 1,200 degrees Fahrenheit. Such may accordingly enable, at least in part, operation of the hypersonic propulsion engine 200 at such hypersonic flight operating conditions.

Moreover, although the exemplary intercooler 308 is depicted as a fuel-cooled intercooler 308, in other embodiments, the intercooler 308 may additionally, or alternatively, be an air-cooled intercooler 308. For example, in alternative embodiments, the turbine engine 202 may be configured to provide a flow of cooled compressor bleed air to act as the heat exchange fluid for the intercooler 308 (similar to the exemplary embodiment discussed above with reference to FIG. 5, except that the cooled compressor bleed air through the forward frame strut 256 may flow through the intercooler 308 to extract heat from an airflow passing over the forward frame strut 256). Additionally, or alternatively, the turbine engine 202 may utilize a water-based thermal fluid (i.e., a fluid including at least 51% water) with the intercooler 208. With such an exemplary embodiment, the thermal fluid may be configured to change phases, such that the thermal fluid is configured to change between a liquid phase and gaseous phase during operation.

Notably, although the hypersonic propulsion engine 200 depicted in FIG. 6 includes both the inlet precooler 248 and the intercooler 308, in certain exemplary embodiments, the hypersonic propulsion engine 200 may not include both of such cooling features.

Part D: Thermal Bus

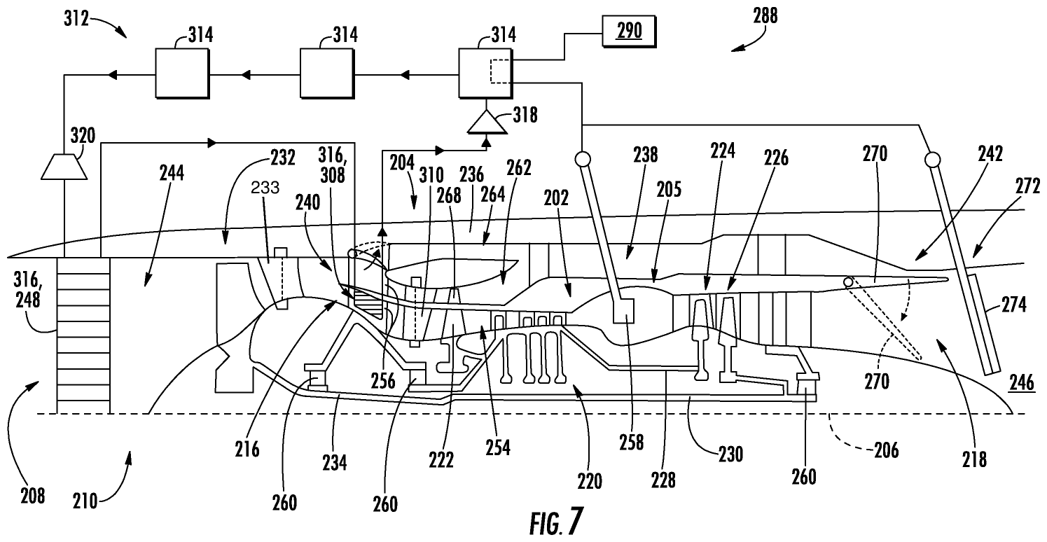

Referring now to FIG. 7, an exemplary hypersonic propulsion engine 200 in accordance with yet another exemplary embodiment of the present disclosure is depicted. The exemplary hypersonic propulsion engine 200 of FIG. 7 may be configured in substantially the same manner as the exemplary hypersonic propulsion engine 200 described above with reference to FIGS. 2 and 3. However, for the embodiment of FIG. 7, the hypersonic propulsion engine 200, and/or a hypersonic aircraft 100 incorporating the hypersonic propulsion engine 200, includes a thermal transport bus 312. For the embodiment shown, the thermal transport bus 312 includes one or more heat sink exchangers 314 and one or more heat source exchangers 316.

The thermal transport bus 312 further includes an intermediary heat exchange fluid flowing therethrough and may be formed of one or more suitable fluid conduits. The heat exchange fluid may be an incompressible fluid having a high temperature operating range. For example, in certain embodiments, heat exchange fluid may be a water and ethanol mixture, or any suitable dielectric fluid. A compressor/pump 318 is provided in fluid communication with the heat exchange fluid in the thermal transport bus 312 for generating a flow of the heat exchange fluid through the thermal transport bus 312. The compressor/pump 318 may be powered by an electric motor, or alternatively may be in mechanical communication with and powered by, e.g., the turbine engine 202.

Moreover, as noted above, the exemplary thermal transport bus 312 includes a plurality of heat source exchangers 316 in thermal communication with the heat exchange fluid in the thermal transport bus 312. The plurality of heat source exchangers 316 are configured to transfer heat from, e.g., one or more of the systems of the hypersonic propulsion engine 200 (or in operable communication with the hypersonic propulsion engine 200, such as the aircraft incorporating the hypersonic propulsion engine 200) to the heat exchange fluid in the thermal transport bus 312. For example, for the embodiment depicted, the plurality of heat source exchangers 316 includes the inlet precooler 248 and the intercooler 308 thermally coupled to, or otherwise integrated into, the forward frame struts 256 of the hypersonic propulsion engine 200 within the core air flowpath 254 of the turbine engine 202.

However, in other embodiments, the thermal transport bus 312 may further include any other suitable heat source exchangers 316, such as one or more surface heat source exchangers 316 thermally coupled to a flowpath surface of the hypersonic propulsion engine 200 or hypersonic aircraft 100, accessory system heat source exchangers 316 (such as a lubrication oil system heat source exchanger, an electric machine heat source exchanger, etc.).

For the embodiment depicted, the thermal transport bus 312 includes two heat source exchangers 316 arranged in series flow along the thermal transport bus 312. However, in other exemplary embodiments, any other suitable number of heat source exchangers 316 may be included and one or more of the heat source exchangers 316 may be arranged in parallel flow along the thermal transport bus 312. For example, in other embodiments, there may be at least three heat source exchangers 316 in thermal communication with the heat exchange fluid in the thermal transport bus 312, or alternatively, there may be at least four heat source exchangers 316, at least five heat source exchangers 316, or at least six heat source exchangers 316 in thermal communication with heat exchange fluid in the thermal transport bus 312.

Additionally, the exemplary thermal transport bus 312 of FIG. 7 further includes at least one heat sink exchanger 314 permanently or selectively in thermal communication with the heat exchange fluid in the thermal transport bus 312. The at least one heat sink exchanger 314 is/are located downstream of the plurality of heat source exchangers 316 and is/are configured for transferring heat from the heat exchange fluid in the thermal transport bus 312, e.g., to atmosphere, to fuel, to a bypass stream, etc. For example, for the embodiment depicted, the thermal transport bus 312 includes a fuel heat sink exchanger 314 thermally coupled to the fuel delivery system 288 for transferring heat from the exchange fluid in the thermal transport bus 312 to a fuel flow through the fuel delivery system 288. Additionally, the thermal transport bus 312 includes two additional heat sink exchangers 314, which may be, e.g., atmospheric heat sink exchangers 314 for transferring heat from the heat exchange fluid to, e.g., an atmospheric airflow (through, e.g., a surface heat exchanger).

For the embodiment of FIG. 7, the at least one heat sink exchanger 314 of the thermal transport bus 312 depicted includes a plurality of individual heat sink exchangers 314. More particularly, for the embodiment of FIG. 7, the at least one heat sink exchanger 314 includes three heat sink exchangers 314 arranged in series. However, in other exemplary embodiments, the at least one heat sink exchanger 314 may include any other suitable number of heat sink exchangers 314. For example, in other exemplary embodiments, a single heat sink exchanger 314 may be provided, at least two heat sink exchangers 314 may be provided, at least four heat sink exchangers 314 may be provided, or at least five heat sink exchangers 314 may be provided. Additionally, in still other exemplary embodiments, two or more of the at least one heat sink exchangers 314 may alternatively be arranged in parallel flow with one another.

Referring still to FIG. 7, the exemplary thermal transport bus 312 depicted further utilizes a refrigeration cycle to more efficiently remove heat from the various heat source exchangers 316. Specifically, the thermal transport bus 312 includes the compressor/pump 318 for compressing the heat exchange fluid in the thermal transport bus 312, and an expansion device 320 for expanding the heat exchange fluid in the thermal transport bus 312. With such a configuration (and others), the heat exchange fluid may not be an incompressible fluid. Also for the configuration shown, the compressor/pump 318 is in fluid communication with the heat exchange fluid at a location downstream of the heat source exchangers 316 and upstream of the at least one heat sink exchanger 314. By contrast, the expansion device 320 is in fluid communication with the heat exchange fluid at a location downstream of the at least one heat sink exchanger 314 and upstream of the heat source exchangers 316. In such an exemplary embodiment, the compressor/pump 318 may be driven by, e.g., an electric motor, or alternatively may be in mechanical communication with and driven by a rotary component of the turbine engine 202. Notably, with such a configuration, the one or more heat sink exchangers 314 acts as a condenser, and the plurality of heat source exchangers 316 acts as an evaporator. Such a configuration may allow for more efficient heat removal from the various heat source exchangers 316, and heat transfer to the one or more heat sink exchangers 314. Further, such a configuration may allow for the transfer of heat from the thermal transport bus 312 to relatively high temperature locations. For example, in certain exemplary embodiments, the ambient temperature can be relatively high during hypersonic flight operating conditions. Accordingly, such a configuration may allow the thermal transport bus 312 to transfer heat to such relatively high ambient locations.

It should be appreciated, that in certain exemplary embodiments, the expansion device 320 may be utilized as a power generating device configured to generate rotational power from a flow of heat exchange fluid therethrough. Further, in other exemplary embodiments, the pump 318 and the expansion device 320 may be switched (i.e., such that the pump 318 compresses the thermal fluid upstream of the heat source heat exchangers 316).

It should also be appreciated, however, that the thermal transport bus 312 depicted is provided by way of example only, and that in other exemplary embodiments, the thermal transport bus 312 may be configured in any other suitable manner. For example, in other exemplary embodiments, the thermal transport bus 312 may not be configured to operate under a refrigeration cycle, i.e., the thermal transport bus 312 may not include one or both of the compressor 318 or the expansion device 320, and the heat exchange fluid may not be a phase change fluid. Additionally, in other exemplary embodiments, the thermal transport bus 312 may not include certain other components depicted in FIG. 7, or alternatively may include other components not described herein.

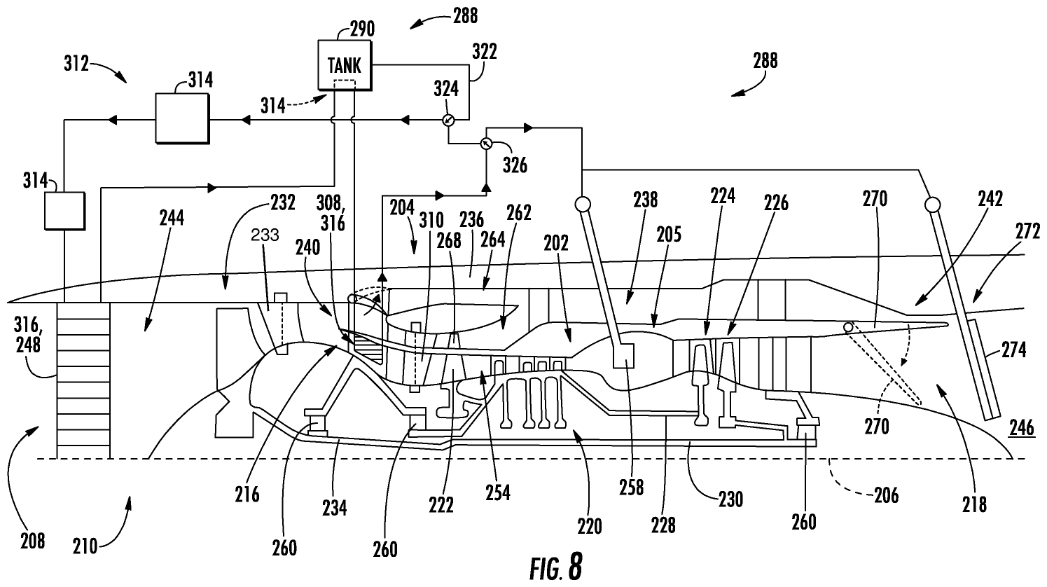

For example, in other embodiments, the thermal transport bus 312 may utilize fuel as the heat transfer fluid exchange fluid. More particularly, referring now to FIG. 8, an exemplary hypersonic propulsion engine 200 in accordance with still another exemplary embodiment of the present disclosure is depicted. The exemplary hypersonic propulsion engine 200 of FIG. 8 may be configured in substantially the same manner as the exemplary hypersonic propulsion engine 200 described above with reference to FIG. 7. However, as noted, for the embodiment of FIG. 8, the thermal transport bus 312 utilizes fuel as the heat transfer fluid exchange fluid.

For example, as is depicted, the thermal transport bus 312 includes a fuel line 322 for providing a flow of fuel from the fuel tank 290. Fuel from the fuel line 322 is fluidly coupled to the thermal transport bus 312 through a first valve 324. As is depicted by the directional arrows, the fuel flows through the thermal transport bus 312 to a first heat sink exchanger 314 and a second heat sink exchanger 314, reducing a temperature of the fuel flow. The fuel flow is then transported through the thermal transport bus 312 to the inlet precooler 248/first heat source exchanger 316. Moreover, for the embodiment depicted, the fuel tank 290 itself is utilized as a heat sink exchanger 314, and more particularly, is configured as a third heat sink exchanger 314. The fuel is then provided to the intercooler 308 /second heat source exchanger 316. Referring still to FIG. 8, for the embodiment depicted, fuel is then provided to the combustion section 205 of the turbine engine 202 and augmenter 272.

In at least certain exemplary aspects of the thermal transport bus 312 depicted in FIG. 8, it will be appreciated that the fuel may be configured to change phases during operation within the thermal transport bus 312. For example, the fuel may be configured to change from a liquid phase to a gaseous phase within the inlet precooler 248, from a gaseous phase back to a liquid phase through use of the tank 290 as the heat sink exchanger 314, and back from a liquid phase to a gaseous phase at the intercooler 308. In certain embodiments, the thermal transport bus 312 may include another heat sink exchanger 314 downstream of the intercooler 308 for changing the fuel from the gaseous phase back to the liquid phase. Additionally, or alternatively, in certain exemplary aspects, the thermal transport bus 312 may be configured to vaporize, or change at least a portion of the liquid fuel within the tank into a gaseous phase. With such an exemplary aspect, the gaseous fuel within the tank may be transferred through the fuel line 322 to the thermal transport bus 312, or alternatively, may be utilized for other purposes. In at least certain exemplary embodiments, the fuel may be, e.g., a Hydrogen fuel.

Briefly, for the embodiment depicted, the exemplary thermal transport bus 312 further includes a second valve 326 downstream of the intercooler 308/heat source exchanger 316. The second valve 326 is fluidly coupled to the first valve 324 through a bridge line 328. The bridge line 328 may facilitate a recirculation of fuel (i.e., from the second valve 326 to the first valve 324), or alternatively, may facilitate bypassing the fuel around one or more of the heat source exchangers 316, and more particularly, around the inlet precooler 248 and intercooler 308 (i.e., from the first valve 324 to the second valve 326).

Notably, however, in other embodiments, the exemplary thermal transport depicted in FIG. 8 may have any other suitable configuration, such as any other suitable number or positioning of heat sink exchangers 314, heat source exchangers 316, valves, etc.

Part E: Surface Cooling

It will further be appreciated that given the relatively high ambient temperatures present during hypersonic flight operations, one or both of the hypersonic propulsion engine 200 and the aircraft including the hypersonic propulsion engine 200 may include one or more flowpath walls 328 defining a flowpath surface 330 and having a cooling assembly thermally operable therewith for reducing a temperature of the flowpath surface 330 of the flowpath wall 328.

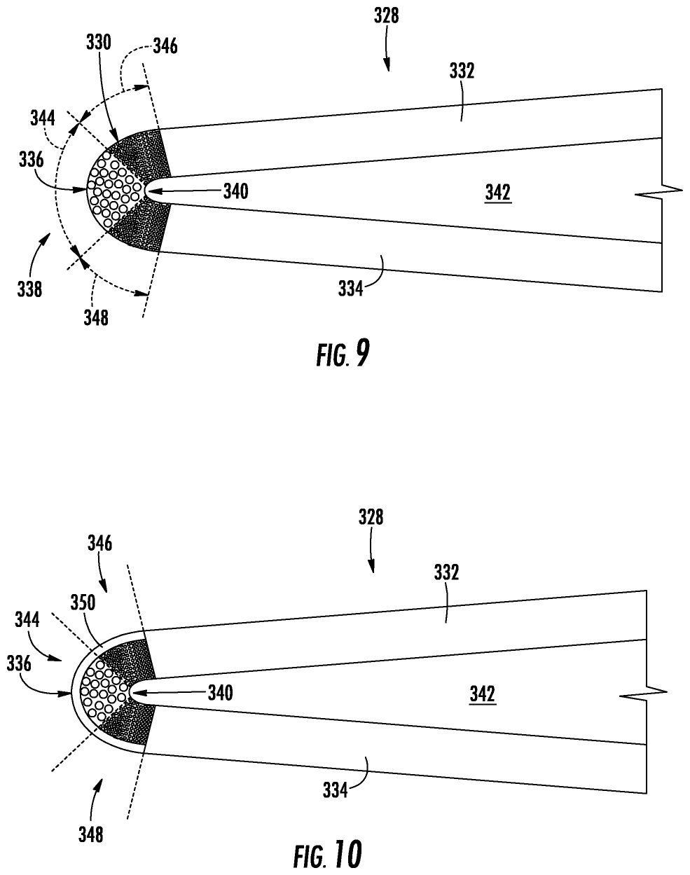

For example, referring to FIG. 9, a cross-sectional view of a flowpath wall 328 defining a flowpath surface 330 in accordance with an exemplary aspect of the present disclosure is provided. More specifically, for the embodiment shown, the flowpath surface 330 is configured as a leading edge. The leading edge may be, e.g., a leading edge of ducting assembly 204 of the hypersonic propulsion engine 200 (e.g., a forward-most edge of the ducting 204 depicted, e.g., in FIG. 2), a leading edge of the turbine engine 202 (such as, e.g., a forward-most edge of the spinner 306 of FIG. 5), a leading edge of a wing of the aircraft (e.g., a forward-most edge of the wings 108, 110 of FIG. 1), a nose of the aircraft (e.g., at forward end 102 of aircraft 100 of FIG. 1), etc.

As is shown in the embodiment depicted, the flowpath wall 328 defining the flowpath surface 330 is generally formed by a first wall section 332 and a second wall section 334. More specifically, the first wall section 332 and the second wall section 334 each include outer surfaces together forming the flowpath surface 330. Moreover, for the embodiment shown, the outer surfaces of the first wall section 332 and the second wall meet at a stagnation point 336.

Referring still to FIG. 9, the first wall section 332 and the second wall section 334 together form a leading edge portion 338 of the flowpath wall 328. The leading edge portion 338 defines an inner surface 340 and the flowpath surface 330. For the embodiment depicted, the cooling assembly includes a cavity 342 positioned between the first wall section 332 and the second wall section 334 and in fluid communication with the inner surface 340 of the leading edge portion 338. Moreover, the leading edge portion 338 is configured as a porous leading edge portion and the cooling assembly is configured to provide a coolant flow through the cavity 342 to the inner surface 340 of the leading edge portion 338, such that the coolant flow may seep through the porous leading edge portion 338 and cool the leading edge portion 338 during operation of the hypersonic propulsion engine 200, e.g., during hypersonic flight operations.

Moreover, for the embodiment shown, the leading edge portion 338 defines a variability in its porosity in order to concentrate a cooling proximate the stagnation point 336 (i.e., is configured as a variable porous section). More specifically, the leading edge portion 338 includes a first section 344, a second section 346, and a third section 348. The first section 344 includes the stagnation point 336, and the second section 346 and third section 348 are arranged on either side of the first section 344. The first section 344 defines a porosity greater than the second section 346 and greater than the third section 348. For example, the first section 344 may define a porosity at least about 10 percent greater than the second section 346, such as at least about 25 percent greater than the second section 346, such as at least about 50 percent greater than the second section 346, such as at least about 100 percent greater than the second section 346, and up to about 1000 percent greater than the second section 346. Notably, the porosity of the second section 346 may be substantially equal to the porosity of the third section 348. As used herein, the term “porosity” with respect to a particular section refers to a ratio of open space to solid material within such section.

The coolant flow may be any suitable coolant material. For example, in certain exemplary embodiments, the coolant flow may be a metal phase change material. For example, the coolant may be a metal configured to change from a solid phase to liquid or gas phase when exposed to temperatures generated during operation of the hypersonic propulsion engine 200 during hypersonic flight operations. Additionally, or alternatively, the coolant may be a metal configured to change from a liquid phase to a gas phase when exposed to temperatures generated during operation of the hypersonic propulsion engine 200 during hypersonic flight operations. However, in other embodiments other suitable coolant may be utilized.

Notably, in other embodiments, any other suitable configuration may be utilized. For example, referring briefly to FIG. 10, a flowpath wall 328 defining a flowpath surface 330 in accordance with another exemplary embodiment of the present disclosure is provided. The exemplary flowpath wall 328 of FIG. 10 may be configured in substantially the same manner as exemplary flowpath wall 328 of FIG. 9. Notably, however, for the embodiment of FIG. 10, the leading edge portion 338 of the flowpath wall 328 (which is porous for the embodiment depicted) is filled with a material. More specifically, the flowpath surface 330 of the leading edge portion 338 of the flowpath wall 328 is filled with a metal material 350 that may have a relatively low melting point, such that the metal filling the pores of the outer surface is configured to melt during operation of the hypersonic propulsion engine 200/hypersonic aircraft 100 during high temperature operations, such as hypersonic flight operations. Once the metal filling the pores of the outer surface of the leading edge portion 338 is melted, the coolant may flow through the leading edge portion 338 in a similar manner as described above with reference to FIG. 9.

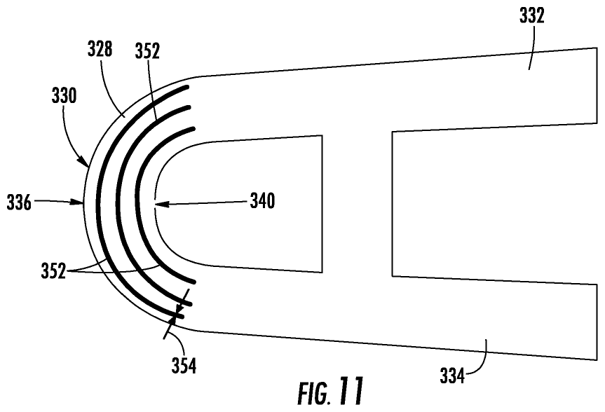

In still other embodiments, the flowpath wall 328 defining the flowpath surface 330 may have still other suitable configurations. For example referring now briefly to FIG. 11, a flowpath wall 328 defining a flowpath surface 330 in accordance with yet another exemplary embodiment is depicted. The exemplary flowpath wall 328 defining the flowpath surface 330 of FIG. 11 includes a plurality of layers of material with compliant interfaces 352 embedded within the leading edge portion 338 and spaced along a thickness of the flowpath wall 328 (e.g., between the inner surface 340 and flowpath surface 330). Specifically, it will be appreciated that in at least certain exemplary embodiments, the compliant interfaces 352 may define a thickness 354. The thickness 354 may be less than about 1 millimeter. The compliant interfaces 352 between the layers of material may effectively act to distribute heat at, e.g., the stagnation point 336 along the flowpath surface 330 to reduce a concentration of the heat at the stagnation point 336. The compliant interface 352 may be a cavity with internal volume defined by the thickness 354 and may be filled with a fluid which has relatively high heat transfer coefficient, such as liquid sodium.

Notably, in at least certain exemplary embodiments, the compliant interfaces 352 may define a smaller thickness 354, and a thickness of the material between interfaces 352 may be less than or equal to about 1 millimeter.

Notably, in still other embodiments, any other suitable configuration may be utilized for reducing a temperature of a flowpath surface 330 of a hypersonic propulsion engine 200 or of an aircraft incorporating a hypersonic propulsion engine 200.

Part F: Alternative Engine Designs

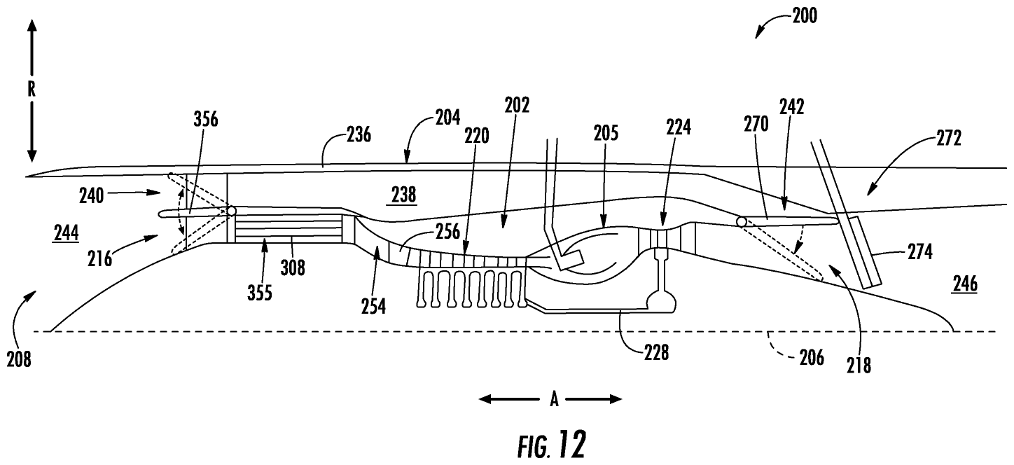

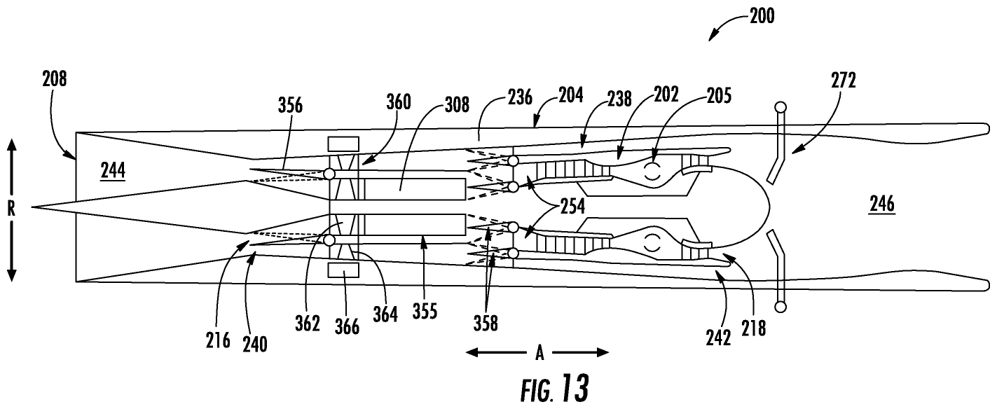

It will further be appreciated that in other exemplary embodiments, the hypersonic propulsion engine 200 may have other suitable configurations. For example, referring now to FIG. 12, a cross-sectional view of a hypersonic propulsion engine 200 in accordance with another exemplary embodiment of the present disclosure is provided. The exemplary hypersonic propulsion engine 200 of FIG. 12 may be configured in a similar manner to the exemplary hypersonic propulsion engine 200 of FIGS. 2 and 3.

For example, the hypersonic propulsion engine 200 generally includes a turbine engine 202 and a ducting assembly 204. The turbine engine 202 includes a compressor section, combustion section 205, and a turbine section arranged in serial flow order. Further, the turbine engine 202 defines a turbine engine inlet 216 upstream of the compressor section and a turbine engine exhaust 218 downstream of the turbine section. Further, the ducting assembly 204 defines a bypass duct 238 having a substantially annular shape and extending around the turbine engine 202. The ducting assembly 204 further defines an afterburing chamber 246 located downstream of the bypass duct 238 and at least partially aft of the turbine engine exhaust 218, as well as an inlet section 244 located at least partially forward of the bypass duct 238 and the turbine engine 202.

However, for the embodiment of FIG. 12, the hypersonic propulsion engine 200 does not include an inlet precooler 248 positioned within the inlet section 244 of the ducting assembly 204 upstream of the turbine engine inlet 216 and/or bypass duct inlet 240 (compare with FIG. 2). Instead, for the embodiment of FIG. 12, the hypersonic propulsion engine 200 includes the intercooler 308 positioned within the core air flowpath 254 of the turbine engine 202, at a location downstream of the turbine engine inlet 216 and upstream of the compressor section. More specifically, the turbine engine 202 includes a precooling duct 355 upstream of the compressor section. The precooling duct 355 is, for the embodiment shown substantially cylindrical, and defines an axial length that is equal to at least about 5% of the turbine engine axial length, such as at least about 10%, such as at least about 15%, such as at least about 20% such as up to about 60%.

Briefly, it will further be appreciated that for the embodiment of FIG. 12, the turbine section of the turbine engine 202 includes a single turbine 224, and the hypersonic propulsion engine 200 does not include a fan 232 (compare with FIG. 2). Further, the hypersonic propulsion engine 200 of FIG. 12 includes an inlet door 356 to the bypass duct 238 configured to vary a flow ratio of inlet airflow between the bypass duct 238 and core air flowpath 254 of the core turbine engine 202. For example, the inlet door 356 may be configured to vary the ratio of inlet airflow between the bypass duct 238 and core air flowpath 254 of the turbine engine 202 between 0:100, 100:0, and a plurality of positions therebetween (such as 50:50, as is depicted in FIG. 12). In another embodiment there may be a fan forward of the heat exchanger 308 driven by a turbine (not shown). This fan may be designed to accommodate the entire air flow stream temperature across the operating regime of the engine. However, in yet another embodiment, the fan may be internally cooled.

It will further be appreciated that in still other exemplary embodiments, the hypersonic propulsion engine 200 may have still other suitable configurations. For example, referring now to FIG. 13, a cross-sectional view of a hypersonic propulsion engine 200 in accordance with another exemplary embodiment of disclosure is provided. The exemplary hypersonic propulsion engine 200 of FIG. 13 may be configured in a similar manner to the exemplary hypersonic propulsion engine 200 of FIG. 12

However, for the embodiment of FIG. 13, the hypersonic propulsion engine 200 includes an additional layer of control of the airflow through the core air flowpath 254. More specifically, for the embodiment of FIG. 13, the hypersonic propulsion engine 200 includes the intercooler 308 located in the core air flowpath 254 upstream of the compressor section, and more particularly in the precooling duct 355. However, the hypersonic propulsion engine 200 further includes a door 358, or rather a pair of doors 358, downstream of the intercooler 308 and at a downstream end of the precooling duct 355 capable of redirecting airflow through the bypass duct 238 into the core air flowpath 254. With the addition of the doors 358, the intercooler 308 (which may simply be referred to as an inlet heat exchanger) may be bypassed during certain operations (e.g., low temperature operations). Alternatively, however, in other operations, the doors 358 may be moved to a closed position (depicted in phantom), such that airflow through the bypass duct 238 remains in the bypass duct 238, and airflow through the core air flowpath 254 of the turbine engine 202 remains in the core air flowpath 254 of the turbine engine 202.

Moreover, for the exemplary engine of FIG. 13, the hypersonic propulsion engine 200 includes a stage of freespinning airfoils 360 (i.e., not connected to any engine shaft of the turbine engine 202). The stage of freespinning airfoils 360 includes an inner stage of airfoils 362, and an outer stage of airfoils 364. The inner stage of airfoils 362 is positioned within the core air flowpath 254 a location upstream of the intercooler 308, and the outer stage of airfoils 364 is positioned within the bypass duct 238. The stage of freespinning airfoils 360 may, e.g., compress an airflow through the bypass duct 238, increasing a temperature of such airflow. In addition, the stage of freespinning airfoils 360 may extract energy from airflow by expanding the core flow entering the heat exchanger 308. In yet another embodiment, the rotational energy may be transferred to a device 366. The device 366 may be a mechanical device, such as an accessory gearbox, or alternatively, may be an electrical device, such as an electric machine configured to extract electrical power from the rotational energy of the stage of freespinning airfoils 360.

Further, in still other embodiments, any other suitable hypersonic propulsion engine 200 structure may be utilized.

Part H: Control Methods

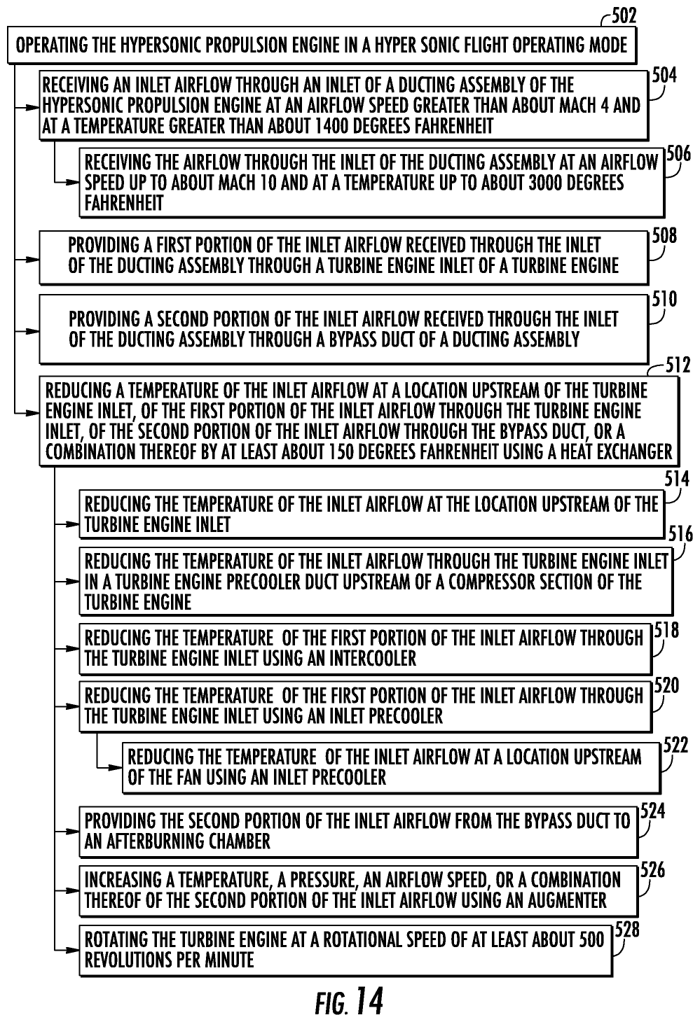

Referring now to FIG. 14, a method 500 for operating a hypersonic propulsion engine in accordance with an exemplary aspect of the present disclosure is provided. The method 500 may be utilized with one or more of the exemplary hypersonic propulsion engines described above with reference to FIGS. 1 through 13.

More specifically, for the exemplary aspect of FIG. 14, the method 500 includes at (502) operating the hypersonic propulsion engine in a hypersonic flight operating mode. Operating the hypersonic propulsion engine in a hypersonic flight operating mode at (502) may include operating the hypersonic propulsion engine at flight speeds greater than about Mach 4.5 and up to about Mach 10, such as greater than Mach 5 and up to Mach 6.

Further, for the exemplary aspect depicted, operating the hypersonic propulsion engine in the hypersonic flight operating mode at (502) includes at (504) receiving an inlet airflow through an inlet of a ducting assembly of the hypersonic propulsion engine at an airflow speed greater than about Mach 4 and at a temperature greater than about 1100 degrees Fahrenheit. More specifically, for the exemplary aspect depicted, receiving the inlet airflow through the inlet of the ducting assembly at (504) includes at (506) receiving the airflow through the inlet of the ducting assembly at an airflow speed up to about Mach 6 and at a temperature up to about 3000 degrees Fahrenheit.

Referring still to FIG. 14, operating the hypersonic propulsion engine in the hypersonic flight operating mode at (502) includes at (508) providing a first portion of the inlet airflow received through the inlet of the ducting assembly through a turbine engine inlet of a turbine engine; and at (510) providing a second portion of the inlet airflow received through the inlet of the ducting assembly through a bypass duct of a ducting assembly. In at least certain exemplary aspects, a ratio of the second portion of air to the first portion of air may be between about 1:1 and about 20:1 while operating the hypersonic propulsion engine in the hypersonic flight operating mode at (502).

Further, as in at least certain of the exemplary embodiments above, in certain exemplary aspects of the method 500, the bypass duct may include a dual stream section, wherein the dual stream section includes an inner bypass duct stream and an outer bypass duct stream. The inner bypass duct stream and the outer bypass duct stream may be in a parallel flow configuration, and a ratio of airflow between the outer bypass duct and inner bypass duct while operating the hypersonic propulsion engine in the hypersonic flight operating mode at (502) may be between 2:1 and 100:1.

Referring still to the exemplary aspect depicted in FIG. 14, operating the hypersonic propulsion engine in the hypersonic flight operating mode at (502) further includes at (512) reducing a temperature of the inlet airflow at a location upstream of the turbine engine inlet, of the first portion of the inlet airflow through the turbine engine inlet, of the second portion of the inlet airflow through the bypass duct, or a combination thereof by at least about 150 degrees Fahrenheit using a heat exchanger. More specifically, for the exemplary aspect depicted, reducing the temperature of the inlet airflow at the location upstream of the turbine engine inlet, of the first portion of the inlet airflow through the turbine engine inlet, of the second portion of the inlet airflow through the bypass duct, or a combination thereof at (512) includes at (514) reducing the temperature of the inlet airflow at the location upstream of the turbine engine inlet.

Alternatively, in certain exemplary aspects, reducing the temperature of the inlet airflow at the location upstream of the turbine engine inlet, of the first portion of the inlet airflow through the turbine engine inlet, of the second portion of the inlet airflow through the bypass duct, or a combination thereof at (512) may include at (516) reducing the temperature of the inlet airflow through the turbine engine inlet in a turbine engine precooler duct upstream of a compressor section of the turbine engine, and/or may include at (518) reducing the temperature of the first portion of the inlet airflow through the turbine engine inlet using an intercooler.

Accordingly, in at least certain exemplary embodiments, reducing the temperature of the inlet airflow at the location upstream of the turbine engine inlet, of the first portion of the inlet airflow through the turbine engine inlet, of the second portion of the inlet airflow through the bypass duct, or a combination thereof at (512) may include at (520) reducing the temperature of the first portion of the inlet airflow through the turbine engine inlet using an inlet precooler. More specifically, in certain exemplary aspects, the hypersonic propulsion engine includes a fan located upstream of the turbine engine inlet. The fan may be drivingly coupled to a turbine of the turbine engine. With such an exemplary aspect, reducing the temperature of the first portion of the inlet airflow through the turbine engine inlet using an inlet precooler at (520) may include at (522) reducing the temperature of the inlet airflow at a location upstream of the fan using an inlet precooler.

Referring still to FIG. 14, it will further be appreciated that in the exemplary aspect depicted, operating the hypersonic propulsion engine in the hypersonic flight operating mode at (502) further includes at (524) providing the second portion of the inlet airflow from the bypass duct to an afterburning chamber; and at (526) increasing a temperature, a pressure, an airflow speed, or a combination thereof of the second portion of the inlet airflow using an augmenter. In certain exemplary aspects, the augmenter may be a rotating detonation combustor, and increasing the temperature, the pressure, the airflow speed, or a combination thereof of the second portion of the inlet airflow at (526) includes providing a fuel flow through the rotating detonation combustor in a non-asymmetrical manner.

Further, still, in the exemplary aspect depicted, operating the hypersonic propulsion engine in the hypersonic flight operating mode at (502) further includes at (528) rotating the turbine engine at a rotational speed of at least about 500 revolutions per minute (“RPM”), such as at least about 1,000 RPM, 5,000 RPM, 10,000 RPM, 15,000 RPM 20,000 RPM, and up to about 100,000 RPM. It will be appreciated that by rotating the turbine engine in such a manner, the hypersonic propulsion engine may provide stability to the aircraft through gyroscopic stabilization forces.

Notably, in other exemplary aspects, the hypersonic engine and/or hypersonic aircraft may be controlled in any other suitable manner. For example, in other exemplary aspects, the hypersonic aircraft may include unique structure and control methodologies for steering during high speed flight, such as during hypersonic flight. For example, the hypersonic engine and/or hypersonic aircraft may include one or more accessory systems that utilize high pressure and/or high speed airflow, such as bleed airflow from the hypersonic engine or from an ambient location. The hypersonic aircraft may include one or more control jets or control nozzles for providing steering forces for the hypersonic aircraft that utilize the high pressure and/or high speed airflow from such accessory system, downstream of the accessory system. The accessory system may be any suitable accessory system, such as a thermal management system or an electrical power generation system, such as a magnetohydrodynamic generator (“MHD generator”). It will be appreciated that a MHD generator generally utilizes a magnetohydrodynamic converter that utilizes a Brayton cycle to transform thermal energy and kinetic energy directly into electricity.

The control jets or control nozzles may be oriented to provide pitch control, yaw control, combinations thereof, etc. The control jets or control nozzles may be located at any suitable location on the hypersonic aircraft, such as at the tail end incorporated into the fuselage, a vertical or horizontal stabilizer, a wing, etc. A suitable control system may be included to adjust an airflow to the one or more control jets or control nozzles.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A hypersonic propulsion engine comprising:
a turbine engine comprising a compressor section, a combustion section, and a turbine section arranged in serial flow order, the turbine engine defining a turbine engine inlet upstream of the compressor section and a turbine engine exhaust downstream of the turbine section;
a ducting assembly defining a bypass duct having a substantially annular shape and extending around the turbine engine, an afterburning chamber located downstream of the bypass duct and at least partially aft of the turbine engine exhaust, and an inlet section located at least partially forward of the bypass duct and the turbine engine inlet; and
an inlet precooler positioned at least partially within the inlet section of the ducting assembly and upstream of the turbine engine inlet, the bypass duct, or both for cooling an airflow provided through the inlet section of the ducting assembly to the turbine engine inlet, the bypass duct, or both.

2. The hypersonic propulsion engine of claim 1, wherein the inlet precooler is positioned upstream of the turbine engine inlet for cooling an airflow provided through the inlet section of the ducting assembly to the turbine engine inlet.

3. The hypersonic propulsion engine of claim 1, wherein the inlet precooler is positioned upstream of both the turbine engine inlet and the bypass duct for cooling an airflow provided through the inlet section of the ducting assembly to the turbine engine inlet and the bypass duct.

4. The hypersonic propulsion engine of claim 1, further comprising:
a fan located forward of the turbine engine inlet and driven by a turbine section of the turbine engine.

5. The hypersonic propulsion engine of claim 4, wherein the fan is located downstream of the inlet precooler.

6. The hypersonic propulsion engine of claim 4, wherein the fan includes a plurality of fan blades, and wherein each of the plurality of fan blades are formed of a ceramic matrix composite material.

7. The hypersonic propulsion engine of claim 4, further comprising:
a stage of guide vanes, wherein the fan comprises a plurality of fan blades, wherein the stage of guide vanes is located downstream of the plurality of fan blades of the fan and upstream of the turbine engine inlet.

8. The hypersonic propulsion engine of claim 7, wherein the stage of guide vanes is a stage of variable guide vanes.

9. The hypersonic propulsion engine of claim 4, wherein the turbine engine defines a cooling duct for a cooling fluid, wherein the fan includes a plurality of fan blades, and wherein the plurality of fan blades are in fluid communication with the cooling duct for receiving at least a portion of the cooling fluid for cooling the plurality of fan blades.

10. The hypersonic propulsion engine of claim 1, wherein the bypass duct comprises a dual stream section, wherein the dual stream section includes an inner bypass duct stream and an outer bypass duct stream, and wherein the inner bypass duct stream and the outer bypass duct stream are in a parallel flow configuration.

11. The hypersonic propulsion engine of claim 10, wherein the compressor section comprises a compressor having a stage of compressor rotor blades, wherein each compressor rotor blade of the stage of compressor rotor blades defines a radially outer end, wherein the ducting assembly includes a stage of airfoils positioned at least partially within the inner bypass duct stream, and wherein the stage of airfoils of the ducting assembly is coupled to the stage of compressor rotor blades at the radially outer ends of the respective compressor rotor blades of the stage of compressor rotor blades.

12. The hypersonic propulsion engine of claim 1, wherein the turbine engine further comprises an engine shaft and one or more bearings supporting the engine shaft, and wherein the one or more bearings are configured as air bearings.

13. The hypersonic propulsion engine of claim 1, further comprising:
an augmenter positioned at least partially within the afterburning chamber.

14. The hypersonic propulsion engine of claim 13, wherein the afterburning chamber is a hyperburner chamber.

15. The hypersonic propulsion engine of claim 1, wherein the afterburning chamber defines a nozzle outlet and an afterburning chamber axial length between the turbine engine exhaust and the nozzle outlet, wherein the turbine engine defines a turbine engine axial length between the turbine engine inlet and the turbine engine exhaust, and wherein the afterburning chamber axial length is at least about 75% of the turbine engine axial length and up to about 500% of the turbine engine axial length.

16. The hypersonic propulsion engine of claim 1, further comprising:
a fuel delivery system for providing a flow of fuel to the combustion section of the turbine engine, wherein the inlet precooler is a fuel-air heat exchanger thermally coupled to the fuel delivery system.

17. The hypersonic propulsion engine of claim 1, wherein the turbine engine defines a core air flowpath extending between the turbine engine inlet and the turbine engine exhaust, and wherein the turbine engine comprises an intercooler in thermal communication with an airflow through the core air flowpath.

18. The hypersonic propulsion engine of claim 1, further comprising:
a flowpath wall defining a flowpath surface, the flowpath surface exposed to substantially hypersonic airflow during operation of the hypersonic propulsion engine; and
a cooling assembly thermally operable with the flowpath surface for reducing a temperature of the flowpath surface.

19. The hypersonic propulsion engine of claim 1, further comprising:
a thermal transport bus having a thermal fluid comprising a one or more heat sink exchangers and one or more heat source exchangers.

20. A method for operating a hypersonic propulsion engine, the method comprising:
operating the hypersonic propulsion engine in a hypersonic flight operating mode, wherein operating the hypersonic propulsion engine in the hypersonic flight operating mode comprises
receiving an inlet airflow through an inlet of a ducting assembly of the hypersonic propulsion engine at an airflow speed greater than about Mach 4 and at a temperature greater than about 1400 degrees Fahrenheit;
providing a first portion of the inlet airflow received through the inlet of the ducting assembly through a turbine engine inlet of a turbine engine;
providing a second portion of the inlet airflow received through the inlet of the ducting assembly through a bypass duct of a ducting assembly; and
reducing a temperature of the inlet airflow at a location upstream of the turbine engine inlet, of the first portion of the inlet airflow through the turbine engine inlet, of the second portion of the inlet airflow through the bypass duct, or a combination thereof by at least about 150 degrees Fahrenheit using a heat exchanger.
